(19) United States
(12) Patent Application Publication
(10) Pub. No.: US 2025/0360847 A1
(43) Pub. Date: Nov. 27, 2025

(54) SIDE-PULL LOWER ANCHOR STRAP FOR CHILD RESTRAINT SYSTEMS

(71) Applicant: Indiana Mills & Manufacturing, Inc., Westfield, IN (US)

(72) Inventors: Brian Nelson Coffman, Westfield, IN (US); Jun Wang, Wuxi City (CN)

(73) Assignee: Indiana Mills & Manufacturing, Inc., Westfield, IN (US)

(21) Appl. No.: 19/217,489

(22) Filed: May 23, 2025

Related U.S. Application Data
(60) Provisional application No. 63/651,502, filed on May 24, 2024.

(51) Int. Cl. B60N 2/28; A44B 11/12

(52) U.S. Cl. CPC B60N 2/2806; A44B 11/125; B60N 2/2887

(57) ABSTRACT

An anchor strap device is configured to be tightened via a side pulling action relative to a child safety seat. The anchor strap device includes a connector configured to connect to an anchor in a vehicle. The anchor strap device includes an adjustment strap and an adjuster. The adjustment strap has an adjuster end secured to the adjuster. The adjuster is configured to maintain tension in the adjustment strap. The anchor strap device includes a guide, and the adjustment strap extends through the guide. The adjustment strap is routed through the adjuster, and the adjustment strap has a free end that extends from the adjuster.

### CROSS REFERENCE TO RELATED APPLICATIONS

This application claims the benefit of U.S. Patent Application No. 63/651,502, filed May 24, 2024, which is hereby incorporated by reference.

### BACKGROUND

Child car seats or Child Restraint Systems (CRS) are difficult to install into cars, often requiring caregivers to exert considerable strength inside a car. As a result, most car seats are installed loose or otherwise incorrectly. Improper installation of the seat may result in significant injuries to any occupant of the seat if an accident or other incident occurs.

Thus, there is a need for improvement in this field.

### SUMMARY

As noted before, installing a child safety seat can be a difficult and laborious process. For example, it has been found that tightening Lower Anchors and Tethers for Children (LATCH) straps must be generally done only with arm strength with little or no opportunity to leverage body strength and weight. Installers or users of the child safety seat often have to climb into the vehicle in order to properly tighten the LATCH or Isofix strap when installing forward facing child safety seats. Sometimes, this installation even requires the installer to climb into the child safety seat to further tighten the LATCH or Isofix strap.

A side-pull seat anchor strap device has been developed to address these as well as other issues. The side-pull anchor strap device is configured to secure a child safety seat to Isofix, LATCH, or other types of anchors commonly found in vehicle seats of modern vehicles. The anchor strap device allows the installer to stand outside of a vehicle and pull on one strap to fully tighten the side-pull anchor strap device so as to secure the child seat in the vehicle. Using one simple motion, the installer is able to tighten to the appropriate tightness while still standing outside the vehicle. With this configuration, the installer is able to use their own weight to aid tightening. In some cases, the side-pull anchor strap device uses either a two or three belt block and tackle design (e.g., gun or luff tackle). The block and tackle in the anchor strap device doubles or triples input force and reduces load requirements of the adjuster like the cam buckle. This design also facilitates the use of current, proven occupant load-bearing components.

The anchor strap device has a unique web or belt routing configuration to multiply input forces from the installer to directly tighten the child safety seat with one pulling motion at convenient angles outside the vehicle. The anchor strap device has an adjustment strap or web where the installer pulls to tighten the anchor strap device. The adjustment strap in some cases has a loop or handle where the installer pulls on the adjustment strap. Tension in the anchor strap device is maintained via an adjuster such as a cam buckle. The adjuster defines an adjustment strap exit opening from where the adjustment strap extends. The adjustment strap opening for the adjustment strap is located near an anchorage point where the anchor strap device is anchored to the anchor in the vehicle seat. With the adjustment strap opening located proximal to the anchorage point, a majority of the pulling force applied to the adjustment strap is used to tighten the child seat.

A primary load or cover section of the adjustment strap covers or is located on top of a tension section of the adjustment strap. By utilizing friction in this routing path of the adjustment strap, tension loss through webbing slip is minimized. The adjuster is directly connected to an anchor connector (e.g., hook or mini-connector) with two degrees of freedom to adjust the load path/pull angle and to be agnostic as to which hand is required for tensioning. These two degrees of freedom for the connector also directs the main load used to tighten the child seat in a downward direction rather than in a direction that moves the child seat in a lateral direction. A minimal distance between the adjuster and the connector is used to convert the lateral pulling force of the installer into pulling the adjustment strap through the adjuster rather than pulling the seat horizontally towards the installer. It was found that a 50-millimeter (mm) bridge sew was too long. The rotating connection between adjuster and connector allows the adjuster to properly align to the seat belt path for most direct web flow. The low tightening resistance in the adjuster translates to maximum pulling force during strap tightening.

The user tightens the adjustment strap to the appropriate tightness while standing outside the vehicle. Consequently, less effort is required, and the seat retaining force is high. The adjustment strap design keeps the cam buckle out of the child restraint seat belt path such that the adjuster or any hardware does not interfere with the child safety seat. The user pulls the adjustment strap horizontally from outside the vehicle to tighten the seat. In one case, the adjustment strap is pulled at a 30-degree angle offset from horizontal. The adjuster avoids misuse that can cause safety issues. The adjustment strap can be removed by loosening the adjuster. The loosening force in most cases is low. During development, it was found that any twisting of the adjustment strap made the anchor strap device harder to use. The adjustment strap is designed to avoid getting twisted.

It was found that of current child seat core products, the lift/push cam style adjusters provide the least resistance when pulling web through the adjuster. It was further discovered that web guiding adjusters allow for variations in pulling angles with minimal increases in friction. The system includes a below adjuster pulling-web exit or strap adjustment opening to help translate lateral pulling force to the tightening force. In one form, a 38 mm webbing is used for the adjustment strap. The block and tackle design of the system is again used to increase tightening force. The system further includes bottom layer tightening via a tension section of the adjustment strap. Pulling the tension section of the adjustment strap at the bottom layer of the belt path routing reduces friction and clamping effect of the tightening adjustment strap.

The system in some variations further has mini-connectors at both ends of the anchor strap device. The mini-connectors release on both sides of the device to create release options for varying installation environments. In other examples, these connectors are pull-to-release type mini-connectors. The system further has an ergonomic handle on the adjustment strap to provide installers a comfortable pulling grip. Child seat installers tend to pull with more force on the handle, and as such, a more comfortable grip point is helpful.

In other variations, the adjustment strap is configured so that the adjuster sits inside the child restraint system belt path to get ideal belt routing while tightening the adjustment strap. Different adjuster styles can be used to reduce friction in the adjuster. For example, a cam buckle style type adjuster (e.g., A-LOK® brand adjuster) can be used. Once more, the block and tackle style web path gives the user more leverage when tightening.

The systems and techniques as described and illustrated herein concern a number of unique and inventive aspects. Some, but by no means all, of these unique aspects are summarized below.
Aspect 1 generally concerns a system.
Aspect 2 generally concerns the system of any previous aspect including a vehicle.
Aspect 3 generally concerns the system of any previous aspect in which the vehicle has a door.
Aspect 4 generally concerns the system of any previous aspect in which the vehicle has a door opening.
Aspect 5 generally concerns the system of any previous aspect in which the vehicle has a vehicle seat.
Aspect 6 generally concerns the system of any previous aspect in which the vehicle has an Isofix safety system.
Aspect 7 generally concerns the system of any previous aspect in which the vehicle has one or more anchors.
Aspect 8 generally concerns the system of any previous aspect in which the vehicle seat has the anchors.
Aspect 9 generally concerns the system of any previous aspect including a child safety seat.
Aspect 10 generally concerns the system of any previous aspect in which the child safety seat is mounted in the vehicle.
Aspect 11 generally concerns the system of any previous aspect in which the child safety seat is mounted on the vehicle seat.
Aspect 12 generally concerns the system of any previous aspect in which the child safety seat includes a harness.
Aspect 13 generally concerns the system of any previous aspect including an anchor strap device.
Aspect 14 generally concerns the system of any previous aspect in which the anchor strap device is configured to secure the child safety seat in the vehicle.
Aspect 15 generally concerns the system of any previous aspect in which the anchor strap device is configured to secure the child safety seat to the vehicle seat.
Aspect 16 generally concerns the system of any previous aspect in which the anchor strap device is configured to secure the child safety seat to the anchors.
Aspect 17 generally concerns the system of any previous aspect in which the anchor strap device is configured to be tightened from outside of the vehicle.
Aspect 18 generally concerns the system of any previous aspect in which the anchor strap device is configured to be tightened via a side pulling action relative to the child safety seat.
Aspect 19 generally concerns the system of any previous aspect in which the anchor strap device includes one or more connectors.
Aspect 20 generally concerns the system of any previous aspect in which the connectors are disposed at opposing ends of the anchor strap device.
Aspect 21 generally concerns the system of any previous aspect in which the connectors are configured to connect to the anchors.
Aspect 22 generally concerns the system of any previous aspect in which the connectors include snap hooks.
Aspect 23 generally concerns the system of any previous aspect in which the connectors include mini-connectors.
Aspect 24 generally concerns the system of any previous aspect in which the connectors define a connector opening.
Aspect 25 generally concerns the system of any previous aspect in which the anchor strap device includes an adjustment strap.
Aspect 26 generally concerns the system of any previous aspect in which the adjustment strap is configured to tighten the anchor strap device.
Aspect 27 generally concerns the system of any previous aspect in which the anchor strap device includes an adjuster.
Aspect 28 generally concerns the system of any previous aspect in which the adjuster is configured to adjust tension of the anchor strap device.
Aspect 29 generally concerns the system of any previous aspect in which the adjuster is configured to maintain tension in the adjustment strap.
Aspect 30 generally concerns the system of any previous aspect in which the adjuster is configured to release tension in the adjustment strap.
Aspect 31 generally concerns the system of any previous aspect in which the adjustment strap is routed through the adjuster.
Aspect 32 generally concerns the system of any previous aspect in which the adjuster includes a frame.
Aspect 33 generally concerns the system of any previous aspect in which the frame has a base.
Aspect 34 generally concerns the system of any previous aspect in which the anchor strap device has a longitudinal axis.
Aspect 35 generally concerns the system of any previous aspect in which the base extends along the longitudinal axis.
Aspect 36 generally concerns the system of any previous aspect in which the base has a hump.
Aspect 37 generally concerns the system of any previous aspect in which the frame has an end wall.
Aspect 38 generally concerns the system of any previous aspect in which the end wall extends transverse to the base.
Aspect 39 generally concerns the system of any previous aspect in which the adjuster has an adjustment strap opening where the adjustment strap extends through the adjuster.
Aspect 40 generally concerns the system of any previous aspect in which the adjustment strap opening is defined in the end wall.
Aspect 41 generally concerns the system of any previous aspect in which the end wall forms an anchor bar.
Aspect 42 generally concerns the system of any previous aspect in which the adjustment strap is secured to the adjuster.
Aspect 43 generally concerns the system of any previous aspect in which the adjustment strap has an adjuster end secured to the adjuster.
Aspect 44 generally concerns the system of any previous aspect in which the adjustment strap has an adjuster loop looped around the anchor bar.
Aspect 45 generally concerns the system of any previous aspect in which the adjustment strap extends through the adjuster along the longitudinal axis.
Aspect 46 generally concerns the system of any previous aspect in which the adjustment strap has a free end that extends from the adjuster.
Aspect 47 generally concerns the system of any previous aspect in which the free end includes a handle.
Aspect 48 generally concerns the system of any previous aspect in which the handle includes a loop in the adjustment strap.
Aspect 49 generally concerns the system of any previous aspect in which the free end extends at a pull angle from the base when tension is applied to the free end of the adjustment strap.
Aspect 50 generally concerns the system of any previous aspect in which the pull angle is defined between the free end of the adjustment strap and the base of the adjuster.
Aspect 51 generally concerns the system of any previous aspect in which the pull angle is defined between the free end of the adjustment strap and the longitudinal axis.
Aspect 52 generally concerns the system of any previous aspect in which the pull angle is at most thirty degrees (30°).
Aspect 53 generally concerns the system of any previous aspect in which the connector is directly coupled to the adjuster.
Aspect 54 generally concerns the system of any previous aspect in which the connector is configured to move with at most two degrees of freedom relative to the adjuster.
Aspect 55 generally concerns the system of any previous aspect in which the connector is configured to pivot about only one axis relative to the adjuster.
Aspect 56 generally concerns the system of any previous aspect in which the two degrees of freedom for the connector directs a main load used to tighten the child seat in a downward direction rather than in a direction that moves the child seat in a lateral direction.
Aspect 57 generally concerns the system of any previous aspect in which the adjuster defines a bridge opening.
Aspect 58 generally concerns the system of any previous aspect in which the bridge opening is defined in the frame.
Aspect 59 generally concerns the system of any previous aspect in which the bridge opening is defined in the base.
Aspect 60 generally concerns the system of any previous aspect in which the connector defines a connector opening.
Aspect 61 generally concerns the system of any previous aspect including a connector strap connecting the connector to the adjuster.
Aspect 62 generally concerns the system of any previous aspect in which the connector strap includes a bridge strap.
Aspect 63 generally concerns the system of any previous aspect in which the bridge strap connects the connector to the adjuster.
Aspect 64 generally concerns the system of any previous aspect in which the bridge strap has a bridge loop looped through the connector opening and the bridge opening.
Aspect 65 generally concerns the system of any previous aspect in which the bridge strap directly connects the connector to the adjuster.
Aspect 66 generally concerns the system of any previous aspect in which the bridge strap limits relative motion between the connector and the adjuster to facilitate transmission of tensioning force of the adjustment strap.
Aspect 67 generally concerns the system of any previous aspect in which the bridge strap has a reinforced portion.
Aspect 68 generally concerns the system of any previous aspect in which the reinforced portion includes three or more layers of webbing.
Aspect 69 generally concerns the system of any previous aspect in which the reinforced portion is stiffened.
Aspect 70 generally concerns the system of any previous aspect in which the adjuster includes a cam buckle.
Aspect 71 generally concerns the system of any previous aspect in which the cam buckle includes a cam pivotally coupled to the frame.
Aspect 72 generally concerns the system of any previous aspect in which the cam buckle includes a shaft where the cam is pivotally coupled to the frame.
Aspect 73 generally concerns the system of any previous aspect in which the cam buckle includes a spring configured to bias the cam to engage the adjustment strap.
Aspect 74 generally concerns the system of any previous aspect in which the spring includes a torsion spring wrapped around the shaft and biased against the cam.
Aspect 75 generally concerns the system of any previous aspect in which the cam includes a lever configured to release the cam from the adjustment strap.
Aspect 76 generally concerns the system of any previous aspect in which the cam includes an engagement portion configured to engage the adjustment strap.
Aspect 77 generally concerns the system of any previous aspect in which the engagement portion includes one or more teeth.
Aspect 78 generally concerns the system of any previous aspect in which the engagement portion and the lever are positioned on opposing sides of the cam.
Aspect 79 generally concerns the system of any previous aspect in which the engagement portion of the cam and the hump of the frame are configured to form a kink in the adjustment strap to secure the adjustment strap.
Aspect 80 generally concerns the system of any previous aspect in which the anchor strap device includes a guide.
Aspect 81 generally concerns the system of any previous aspect in which the guide is configured to guide the adjustment strap.
Aspect 82 generally concerns the system of any previous aspect in which the guide defines a guide slot.
Aspect 83 generally concerns the system of any previous aspect in which the adjustment strap extends through the guide.
Aspect 84 generally concerns the system of any previous aspect in which the adjustment strap extends through the guide slot.
Aspect 85 generally concerns the system of any previous aspect in which the guide has a rectangular shape.
Aspect 86 generally concerns the system of any previous aspect in which the guide is rounded.
Aspect 87 generally concerns the system of any previous aspect in which the adjustment strap is folded together at the guide.
Aspect 88 generally concerns the system of any previous aspect in which the adjustment strap extends from the adjuster to the guide.
Aspect 89 generally concerns the system of any previous aspect in which the adjustment strap has a cover section that extends from the adjuster end to the guide.
Aspect 90 generally concerns the system of any previous aspect in which the adjustment strap has a tension section that extends from the guide to the adjustment strap opening in the adjuster.
Aspect 91 generally concerns the system of any previous aspect in which the cover section covers the tension section of the adjustment strap.
Aspect 92 generally concerns the system of any previous aspect in which the tension section is folded underneath the cover section of the adjustment strap.
Aspect 93 generally concerns the system of any previous aspect in which the cover section and the tension section are arranged to reduce friction during tensioning.
Aspect 94 generally concerns the system of any previous aspect in which the adjustment strap is folded through the guide to form two webbing layers.
Aspect 95 generally concerns the system of any previous aspect in which the connector strap connects the guide to the connector.
Aspect 96 generally concerns the system of any previous aspect in which the connector strap includes a guide strap.
Aspect 97 generally concerns the system of any previous aspect in which the guide strap connects the guide to the connector.
Aspect 98 generally concerns the system of any previous aspect in which the guide strap includes a guide loop looped through the guide.
Aspect 99 generally concerns the system of any previous aspect in which the guide loop is looped through the guide slot.
Aspect 100 generally concerns the system of any previous aspect in which the guide loop includes a connector loop looped through the connector.
Aspect 101 generally concerns the system of any previous aspect in which the connector loop is looped through the connector opening in the connector.
Aspect 102 generally concerns the system of any previous aspect in which the guide strap has an extension portion.
Aspect 103 generally concerns the system of any previous aspect in which the extension portion extends from the guide to the connector.
Aspect 104 generally concerns the system of any previous aspect in which the extension portion extends from the guide loop to the connector loop.
Aspect 105 generally concerns the system of any previous aspect in which the guide strap is configured to twist to minimize twisting of the adjustment strap.
Aspect 106 generally concerns the system of any previous aspect in which the guide strap is configured to twist to facilitate connection of the connector to the anchor.
Aspect 107 generally concerns the system of any previous aspect in which the guide strap is configured to bend to minimize binding of the adjustment strap.
Aspect 108 generally concerns the system of any previous aspect in which the guide strap is configured to bend to facilitate connection of the connector to the anchor.
Aspect 109 generally concerns the system of any previous aspect in which the guide strap is longer than the bridge strap.
Aspect 110 generally concerns the system of any previous aspect in which the guide strap has a single layer of webbing.
Aspect 111 generally concerns the system of any previous aspect in which the adjustment strap between the adjuster and the guide has at least two layers of webbing.
Aspect 112 generally concerns the system of any previous aspect in which the adjustment strap routed between the adjuster and the guide is stiffer than the guide strap.
Aspect 113 generally concerns the system of any previous aspect in which the guide strap extends through the child safety seat.
Aspect 114 generally concerns the system of any previous aspect in which the bridge strap is positioned outside of the child safety seat.
Aspect 115 generally concerns the system of any previous aspect in which the adjuster is positioned at one side of the child safety seat when secured.
Aspect 116 generally concerns the system of any previous aspect in which the adjuster is positioned to face the door opening.
Aspect 117 generally concerns the system of any previous aspect in which the adjustment strap extends outside of the vehicle during tensioning.
Aspect 118 generally concerns the system of any previous aspect in which the anchor strap device uses a two-belt block and tackle design.
Aspect 119 generally concerns the system of any previous aspect in which the anchor strap device uses a three-belt block and tackle design.
Aspect 120 generally concerns the system of any previous aspect in which the adjustment strap opening is located proximal to the anchor so that a majority of pulling force applied to the adjustment strap is used to tighten the child seat.
Aspect 121 generally concerns the system of any previous aspect in which the adjuster is located proximal to the anchor so that a majority of pulling force applied to the adjustment strap is used to tighten the child seat.
Aspect 122 generally concerns the system of any previous aspect in which the adjuster and the connector are directly connected to convert a lateral pulling force of an installer into pulling the adjustment strap through the adjuster rather than pulling the seat horizontally towards the installer.
Aspect 123 generally concerns the system of any previous aspect in which the anchor strap device includes a below adjuster pulling-web exit or strap adjustment opening to help translate lateral pulling force to the tightening force.
Aspect 124 generally concerns the system of any previous aspect in which the adjustment strap is 38 mm webbing.
Aspect 125 generally concerns the system of any previous aspect in which the connectors are pull-to-release type mini-connectors.
Aspect 126 generally concerns the system of any previous aspect in which the anchor strap device includes a single connector.
Aspect 127 generally concerns the system of any previous aspect in which the anchor strap device includes at least two connectors.
Aspect 128 generally concerns the system of any previous aspect in which the anchor strap device includes a connector configured to connect to the anchor in the vehicle.
Aspect 129 generally concerns the system of any previous aspect in which the free end of the anchor strap extends directly from the adjuster towards the door opening of the vehicle.
Aspect 130 generally concerns the system of any previous aspect in which the anchor strap device includes a connector strap connected to the connector.
Aspect 131 generally concerns the system of any previous aspect in which the connector strap is configured to facilitate tensioning of the adjustment strap.
Aspect 132 generally concerns the system of any previous aspect in which the guide defines at least two guide slots.
Aspect 133 generally concerns the system of any previous aspect in which the guide includes a separator bar that separates the guide slots.
Aspect 134 generally concerns the system of any previous aspect in which the anchor strap device includes a sleeve.
Aspect 135 generally concerns the system of any previous aspect in which the sleeve slidably receives the adjustment strap.
Aspect 136 generally concerns the system of any previous aspect in which the sleeve receives the cover section and the tension section of the adjustment strap.
Aspect 137 generally concerns the system of any previous aspect in which the sleeve covers the cover section and the tension section of the adjustment strap.
Aspect 138 generally concerns the system of any previous aspect in which the bridge strap is integrated into the adjuster.
Aspect 139 generally concerns the system of any previous aspect in which the bridge strap is captured in the frame.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a diagram of a child restraint system having a child safety seat secured with an anchor strap device according to one example.

FIG. 2 is a perspective view of the FIG. 1 child safety seat installed in a vehicle.

FIG. 3 is a perspective view of the anchor strap device according to one version.

FIG. 4 is a first side view of the FIG. 3 anchor strap device.

FIG. 5 is a bottom view of the FIG. 3 anchor strap device.

FIG. 6 is a second side view of the FIG. 3 anchor strap device.

FIG. 7 is a top view of the FIG. 3 anchor strap device.

FIG. 8 is a cross-sectional view of the FIG. 3 anchor strap device as taken along line 8-8 in FIG. 7.

FIG. 9 is an enlarged cross-sectional view of the FIG. 3 anchor strap device around a cam buckle in the FIG. 3 anchor strap device.

FIG. 10 is an enlarged perspective view of the cam buckle in the FIG. 3 anchor strap device.

FIG. 11 is a front view of the FIG. 3 anchor strap device.

FIG. 12 is an enlarged cross-sectional view of the FIG. 3 anchor strap device.

FIG. 13 is a bottom perspective view of one end of the FIG. 3 anchor strap device.

FIG. 14 is a top perspective view of the end of the FIG. 3 anchor strap device shown in FIG. 13.

FIG. 15 is a rear view of the FIG. 3 anchor strap device.

FIG. 16 is a top view of an anchor strap device according to another example.

FIG. 17 is a side view of the FIG. 16 anchor strap device.

FIG. 18 is a top view of an anchor strap device according to a further example.

FIG. 19 is an enlarged view of the FIG. 18 anchor strap device proximal to the adjuster.

FIG. 20 is a perspective view of a cam buckle used in the FIG. 18 anchor strap device.

FIG. 21 is an exploded view of the FIG. 20 cam buckle.

FIG. 22 is a perspective view of a frame in the FIG. 20 cam buckle.

FIG. 23 is a cross-sectional view of the FIG. 18 anchor strap device proximal to the adjuster.

### DETAILED DESCRIPTION OF SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

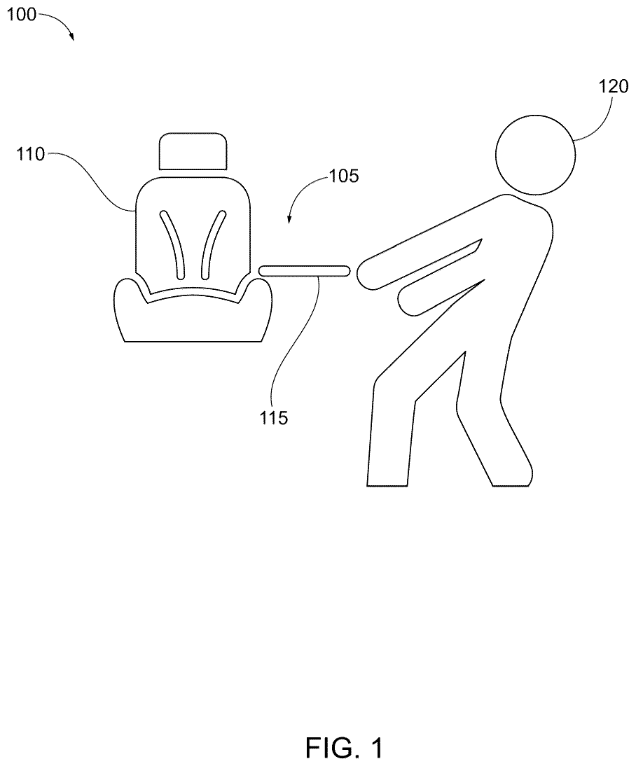

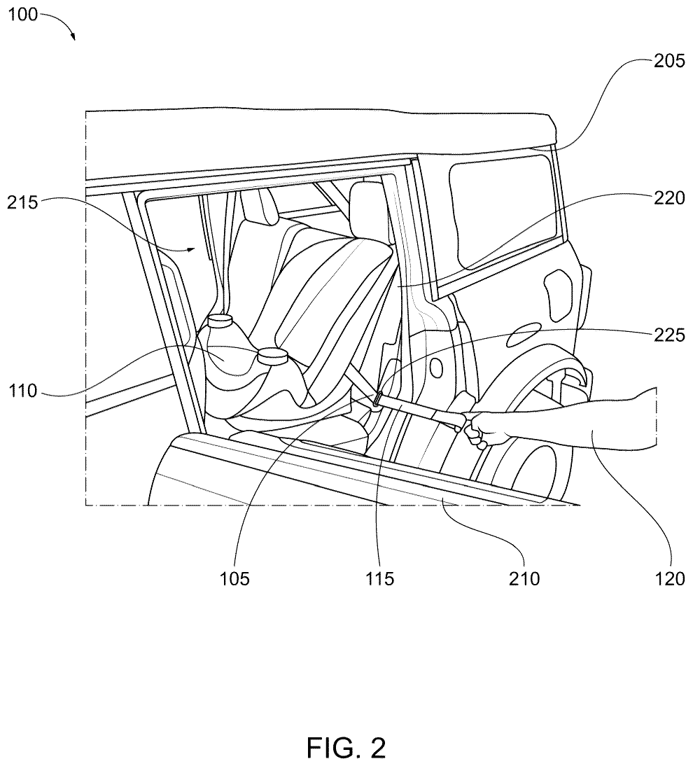

The reference numerals in the following description have been organized to aid the reader in quickly identifying the drawings where various components are first shown. In particular, the drawing in which an element first appears is typically indicated by the left-most digit(s) in the corresponding reference number. For example, an element identified by a “100” series reference numeral will likely first appear in FIG. 1, an element identified by a “200” series reference numeral will likely first appear in FIG. 2, and so on.

FIG. 1 shows a diagrammatic view of a child restraint system 100 according to one example. The system 100 includes an anchor strap device 105 configured to secure a child safety seat 110 to an adult vehicle seat in a vehicle. The anchor strap device 105 includes an adjustment strap 115 that an installer 120 pulls on to tighten the anchor strap device 105 so that the child safety seat 110 is properly secured. As can be seen, the anchor strap device 105 is designed so that the installer 120 is able to pull from the side of the child safety seat 110. This allows the installer 120 to pull on the adjustment strap 115 outside of the vehicle during tightening of the child safety seat 110. Moreover, the installer 120 is able to lean back so as to use the weight of the installer 120 to further tighten the anchor strap device 105.

FIG. 2 shows one example of an installation environment for the system 100. As shown, the child safety seat 110 is installed in a vehicle 205. The vehicle 205 has a door 210 that is able to close a door opening 215 in the vehicle 205. The vehicle 205 further includes a vehicle seat 220 onto which the child safety seat 110 is secured. The depicted vehicle 205 has a LATCH or Isofix system for securing the child safety seat 110 to the vehicle seat 220 via the anchor strap device 105. In the depicted example, the vehicle seat 220 has one or more anchors 225 located where the seat back meets the seat bottom of the vehicle seat 220, but it should be recognized that the anchors 225 can be located elsewhere.

In the depicted example, the vehicle seat 220 has two anchors 225 that are located on opposite sides of the child safety seat 110. With the door 210 open, the installer 120 clips the anchor strap device 105 to one of the anchors 225 of the vehicle 205. Before or after the child safety seat 110 is placed inside the vehicle 205, the installer 120 threads the anchor strap device 105 through the appropriate path in the child safety seat 110 for securing the child safety seat 110 to the vehicle 205. Once the anchor strap device 105 is threaded through the child safety seat 110, the installer 120 clips the anchor strap device 105 to the other anchor 225 in the vehicle seat 220. At this point, the installer 120 is able to tighten the anchor strap device 105 by pulling on the adjustment strap 115 so that the child safety seat 110 is snuggly secured to the vehicle seat 220. Unlike traditional systems where the seat straps need to be tightened within the vehicle 205, the installer 120 is able to pull in a sideways direction on the adjustment strap 115 of the anchor strap device 105 from outside of the vehicle 205. Without being confined inside the vehicle 205, the installer 120 is able to leverage their weight when pulling on the adjustment strap 115 so as to ensure the child safety seat 110 is firmly secured to the vehicle 205. The anchor strap device 105 is further designed to amplify the pulling force of the installer 120 as well as minimize twisting and friction in the anchor strap device 105 so that the installer 120 is able to smoothly tighten the anchor strap device 105 with minimal effort.

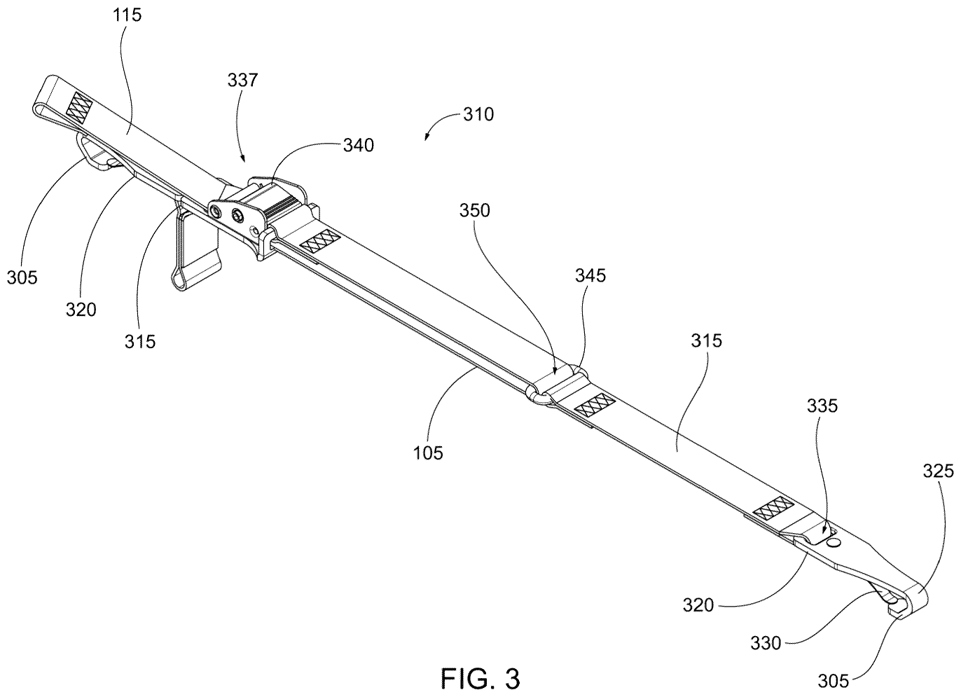

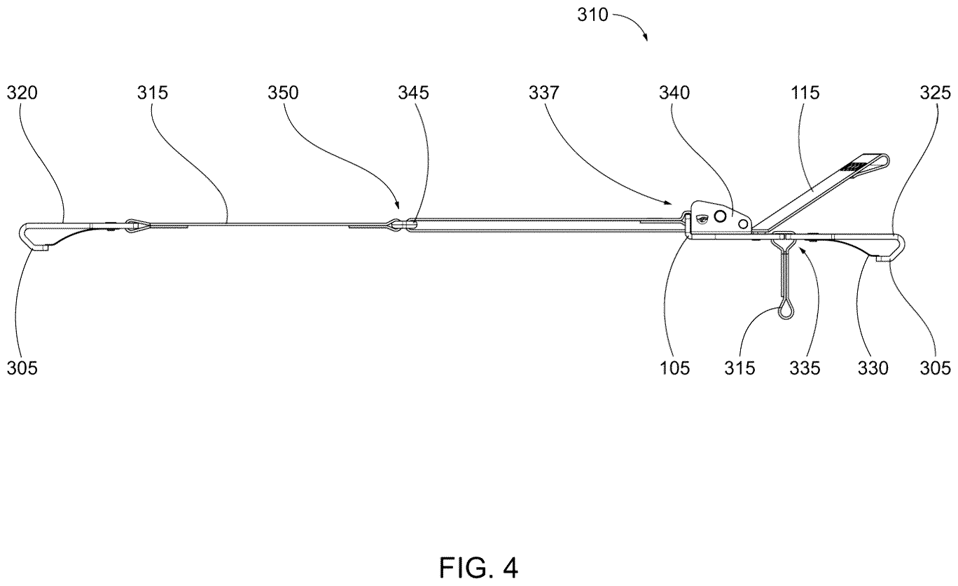

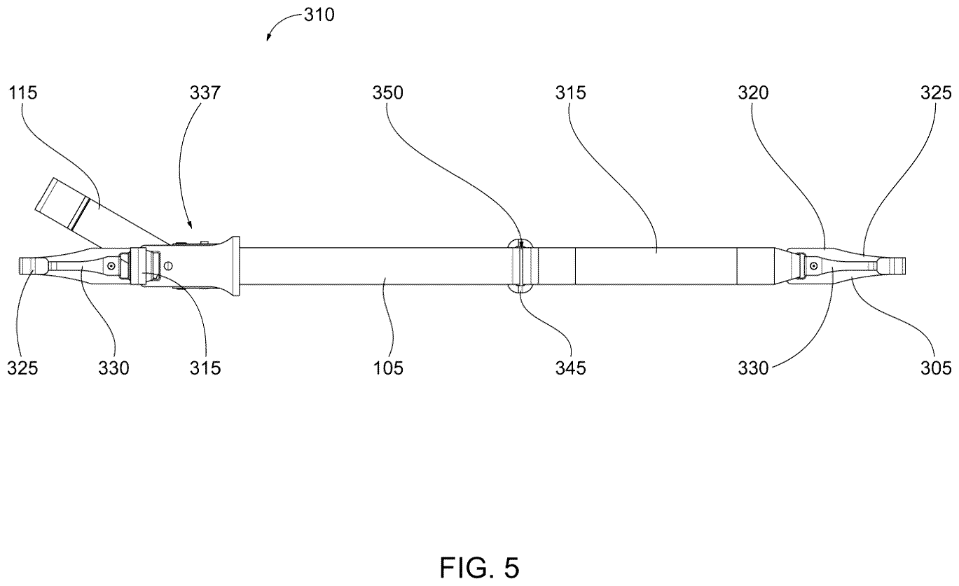

Turning to FIGS. 3, 4, and 5, the anchor strap device 105 includes one or more anchor connectors 305 that are configured to secure to the anchors 225 of the vehicle 205. In the depicted example, the anchor strap device 105 has two anchor connectors 305 that are generally located on opposite ends of the anchor strap device 105. Between the anchor connectors 305, the anchor strap device 105 has a tensioner 310 that is configured to tighten or loosen the anchor strap device 105 via the adjustment strap 115. The tensioner 310 is coupled to the anchor connectors 305 via one or more connector straps 315. In one form, the connector straps 315 are made from a web type material, but the connector straps 315 can be made from other types of materials in other examples. The connector straps 315 are configured to minimize twisting and binding of the adjustment strap 115 in the anchor strap device 105 as the adjustment strap 115 is pulled during tightening.

In the illustrated example, the anchor connectors 305 are in the form of snap hooks 320, but the anchor connectors 305 in other examples can include other types such as mini-connectors and the like. Each snap hook 320 has a hook 325 and a gate 330. The hook 325 is configured to hook onto the anchor 225, and when closed against the hook 325, the gate 330 retains the anchor 225 in the snap hook 320. Both the hook 325 and the gate 330 in one version are made of metal, but the hook 325 and the gate 330 can be made from other materials. In one form, the gate 330 is a flat leaf spring, but the gate 330 can be constructed in other manners. In the illustrated example, one end of the gate 330 is secured to the snap hook 320 via a rivet and the other end is free to engage the hook 325. It should be recognized that the gate 330 can be secured to the hook 325 in other manners such as via welding and/or adhesives. The hook 325 of the anchor connector 305 defines a connector opening 335 wherein the connector strap 315 is secured. The connector opening 335 in the depicted example is in the form of a slot, but the connector opening 335 can be shaped differently in other examples. Moreover, the connector straps 315 can be secured to the anchor connectors 305 in other manners.

Along with the adjustment strap 115, the tensioner 310 includes an adjuster 337 in the form of a cam buckle 340 and a guide 345. In the illustrated example, the adjuster 337 is in the form of the cam buckle 340, but in other examples, the adjuster 337 can include other types of adjusters like tilt lock adjusters. The adjustment strap 115 in one form is made from a web type material, but the adjustment strap 115 can be made from other types of materials and can come in other forms. As shown, one end of the adjustment strap 115 is secured to the adjuster 337. The guide 345 in the depicted example is in the form of a metallic rectangular ring, but the guide 345 can be shaped differently and made from different materials in other examples. The guide 345 defines a guide slot 350 through which the adjustment strap 115 from the adjuster 337 is threaded. At the guide 345, the adjustment strap 115 is folded or bent back upon itself, and the adjustment strap 115 from the guide 345 is threaded through the adjuster 337. To promote smooth sliding of the adjustment strap 115, the guide 345 has a rounded exterior. In other variations, the guide 345 can further include a wheel or collar so as to further reduce friction between the adjustment strap 115 and the guide 345. From the adjuster 337, the adjustment strap 115 has a free end that is pulled by the installer 120 to tighten the tensioner 310 of the anchor strap device 105. The adjuster 337 helps to maintain tension in the adjustment strap 115, and when actuated, the adjuster 337 is able to release tension in the adjustment strap 115.

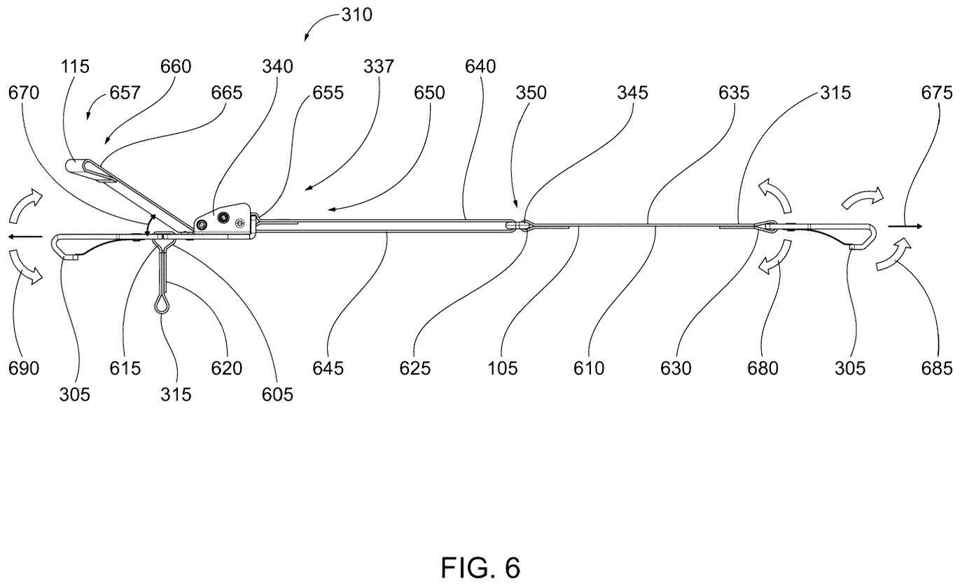

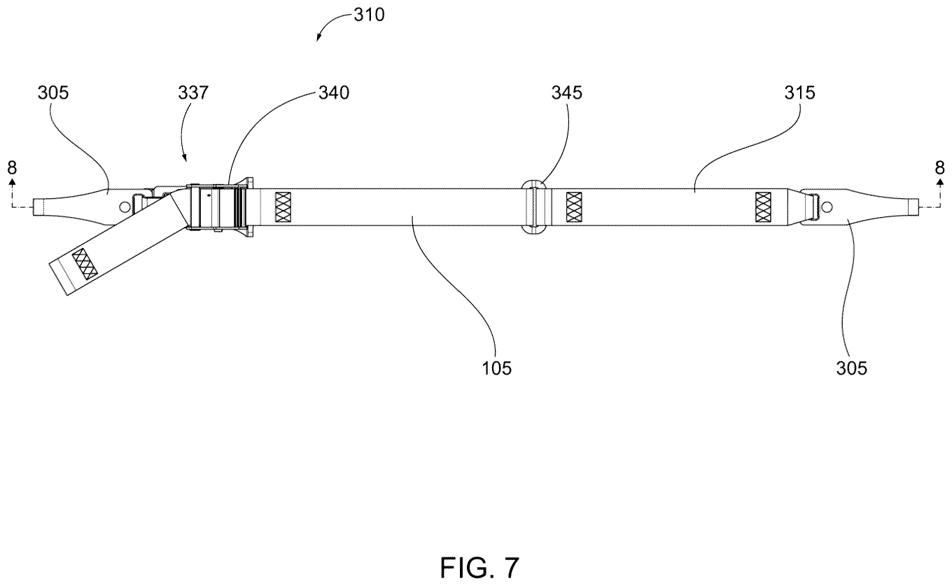

Referring now to FIGS. 6, 7, and 8, the connector straps 315 include a bridge strap 605 and a guide strap 610. The bridge strap 605 directly connects the cam buckle 340 to one of the anchor connectors 305, and the bridge strap 605 connects the guide 345 to the anchor connector 305 at the other end of the anchor strap device 105. As can be seen, the bridge strap 605 is considerably shorter than the guide strap 610. As a result, the cam buckle 340 is located in close proximity to the anchor connector 305 connected via the bridge strap 605. The bridge strap 605 has a bridge loop 615 that connects the anchor connector 305 to the cam buckle 340 via the connector opening 335 in the anchor connector 305. With the bridge loop 615, the anchor connector 305 and the cam buckle 340 are closely connected together. This arrangement positions the cam buckle 340 to one side of the child safety seat 110 to facilitate easy access to the cam buckle 340 and further facilitates the transmission of the tensioning force via the adjustment strap 115. Typically, but not always, the anchor connector 305 at the bridge strap 605 is positioned to engage the anchor 225 that is proximal to the door opening 215. The bridge strap 605 has a reinforced portion 620 that stiffens the connection between the anchor connector 305 and the cam buckle 340 so that the anchor connector 305 is generally only able to pivot relative to the cam buckle 340 along only one axis. In the illustrated example, the bridge strap 605 is folded and sewn together to form three layers at the reinforced portion 620 so as to stiffen the bridge strap 605 at the reinforced portion 620. In other variations, the reinforced portion 620 can include more layers and/or be stiffened in other ways. The bridge strap 605 helps to prevent twisting or binding of the adjustment strap 115 which could inhibit tensioning of the tensioner 310.

The guide strap 610 has a guide loop 625 secured to the guide 345 and a connector loop 630 secured to the anchor connector 305. The guide strap 610 further has an extension portion 635 that extends between the guide loop 625 and the connector loop 630. The guide loop 625 is looped through the guide slot 350 in the guide 345 and sewn to the extension portion 635. The connector loop 630 is looped through the connector opening 335 in the anchor connector 305 and sewn to the extension portion 635. It should be recognized that the guide strap 610 can be connected to the anchor connector 305 and the guide 345 in other manners. As can be seen, the extension portion 635 is a single thin layer of webbing that is able to twist and bend. In other words, the extension portion 635 in the guide strap 610 is more flexible than the adjustment strap 115 in the tensioner 310 so that the guide strap 610 flexes and bends instead of the adjustment strap 115 in the tensioner 310. With the bridge strap 605 flexing and twisting, the adjustment strap 115 can avoid having the twists and bends that tend to make tensioning or loosening of the tensioner 310 more difficult.

During development of the anchor strap device 105, it was discovered that the webbing in traditional designs was compressed behind the child seat and tended to rub against the child seat when moved so as to make tensioning more difficult. In view of this, the routing of the adjustment strap 115 within the tensioner 310 was configured to reduce friction and to make the pulling action of the adjustment strap 115 considerably smoother and easier. To amplify the tensioning force applied, the adjustment strap 115 is again folded so as to extend through the guide 345. As a result, the adjustment strap 115 has two sections, a cover section 640 and a tension section 645. At the cover section 640, the adjustment strap 115 has an adjuster end 650 that is secured to the adjuster 337. In the depicted example, the cover section 640 of the adjustment strap 115 has an adjuster loop 655 secured to the cam buckle 340, but in other variations, the adjuster end 650 of the adjustment strap 115 is secured to the cam buckle 340 in other manners.

When the anchor strap device 105 is secured to the child safety seat 110 and the anchors 225, the cover section 640 faces the child safety seat 110, and the tension section 645 faces the vehicle seat 220. The tension section 645 extends generally parallel to the cover section 640, and the tension section 645 is routed through the adjuster 337. Opposite to the cover section 640 and the tension section 645, the adjustment strap 115, which was routed through the cam buckle 340, has a free end 657 that extends from the cam buckle 340. At the free end 657, the adjustment strap 115 has a handle 660 where the installer 120 is able to grasp and pull on the adjustment strap 115. In the depicted example, the handle 660 includes a handle loop 665 at the free end 657 to facilitate gripping, but the handle 660 can include other types of gripping structures in other examples. As the installer 120 pulls on the adjustment strap 115 to tighten down the child safety seat 110, the cover section 640 remains generally stationary relative to the child safety seat 110 and the tension section 645 moves or glides relative to the cover section 640. In other words, the cover section 640 covers or protects the tension section 645 as the tension section 645 moves when the adjustment strap 115 is pulled. The cover section 640 is still able to maintain the primary tension load as the adjustment strap 115 is pulled. With the guide 345, the cover section 640 and the tension section 645 are normally spaced apart so as to not contact one another, but in cases where contact occurs, the cover section 640 provides a consistent, smooth surface upon which the tension section 645 is able to glide.

The adjustment strap 115 at the free end 657 is pulled at a pull angle 670 relative to a longitudinal axis 675 of the anchor strap device 105 that extends through the cam buckle 340. In some cases, the adjustment strap 115 at the free end 657 extends along or parallel to the longitudinal axis 675 of the anchor strap device 105 such that maximum tension force is applied when the pull angle 670 is around zero degrees (0°). In other cases, the pull angle 670 is at most thirty degrees (30°) with little degradation to the tensioning force.

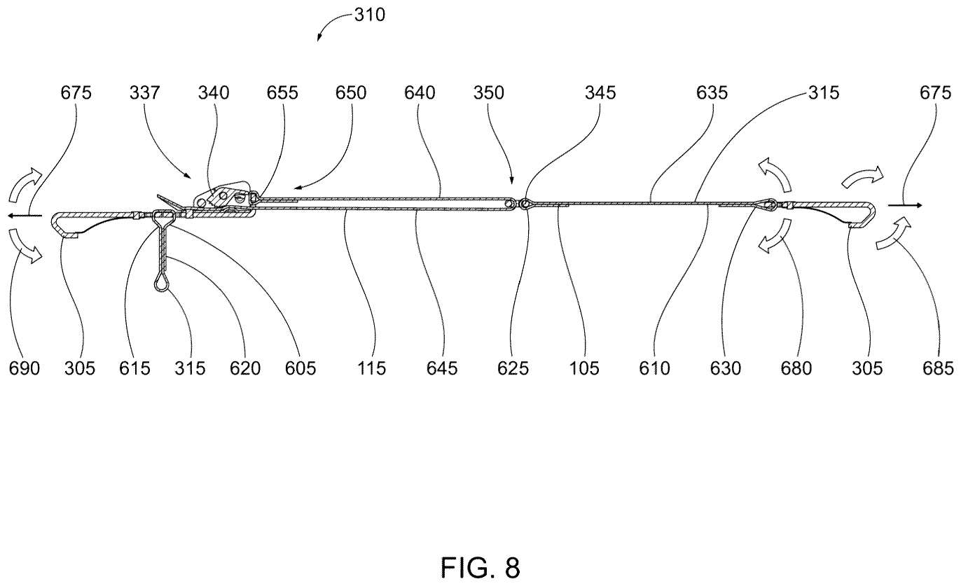

As alluded to before, the tensioner 310 tends to be stiffer and less prone to twisting as compared to the guide strap 610. As can be seen, the cover section 640 and the tension section 645 of the adjustment strap 115 form two layers which is stiffer than the single layer of the guide strap 610. With this construction, the anchor strap device 105 is able to connect to the anchor 225 without twisting or binding the adjustment strap 115 in the tensioner 310. The anchor connector 305 that is connected to the guide strap 610 is able to pivot or bend relative to the longitudinal axis 675, as is indicated by arrows 680 in FIGS. 6 and 8, such that the anchor connectors 305 are able to be bent towards the anchor 225 without bending the cover section 640 and the tension section 645 in the tensioner 310. The guide strap 610 is able to readily twist relative to the tensioner 310, as is indicated by arrows 685 in FIGS. 6 and 8, as compared to the cover section 640 and the tension section 645 in the stiffer tensioner 310. The extension portion 635 is then able to readily twist so as to facilitate anchoring of the anchor connector 305 to the anchor 225 of the vehicle 205. Having the guide strap 610 able to readily twist inhibits twisting of the cover section 640 and the tension section 645 of the adjustment strap 115 so as to provide a smoother and easier tensioning action of the tensioner 310 when the handle 660 of the adjustment strap 115 is pulled as well as during loosening of the anchor strap device 105.

As noted before, one of the anchor connectors 305 is directly coupled to the cam buckle 340 via the bridge strap 605 such that there is little distance between the anchor connector 305 and the cam buckle 340 as compared to the opposite anchor connector 305. As indicated by arrows 690 in FIGS. 6 and 8, the anchor connector 305 at the cam buckle 340 is only able to generally pivot or bend away from the longitudinal axis 675 along a single axis. The reinforced portion 620 in the bridge strap 605 inhibits other relative motions between the anchor connector 305 and the cam buckle 340 such that the anchor connectors 305 has two degrees of freedom for movement. The anchor connector 305 is still able to be bent down towards the anchor 225 in the vehicle seat 220 so as to facilitate anchoring of the anchor connector 305, but this single axis motion inhibits other twisting or binding action that might increase friction or otherwise inhibit the pulling action of the adjustment strap 115 through the adjuster 337. The bending direction of the anchor connector 305 at the adjuster 337 generally matches the direction of the pull angle 670. This configuration allows the free end 657 of the adjustment strap 115 to be generally pulled straight through the cam buckle 340 with minimal friction.

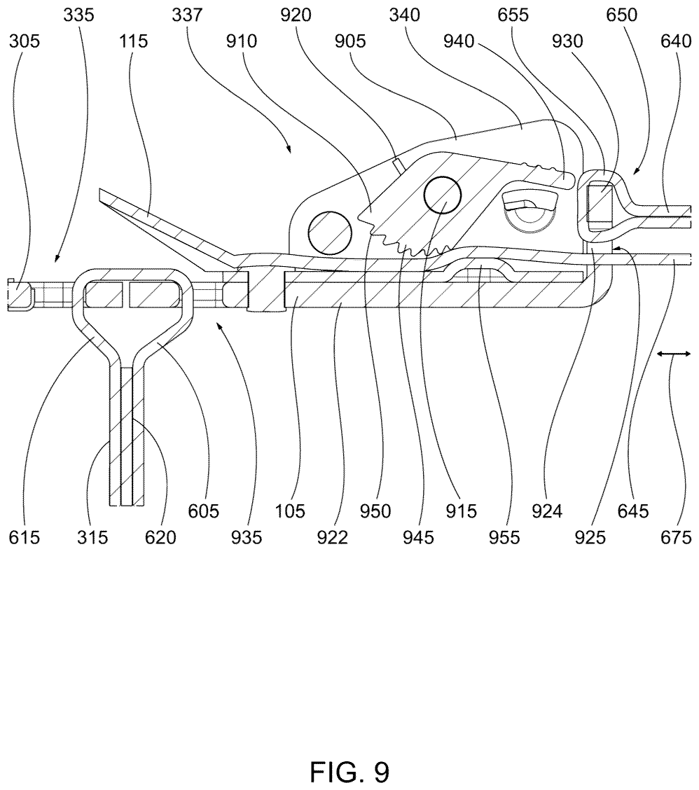

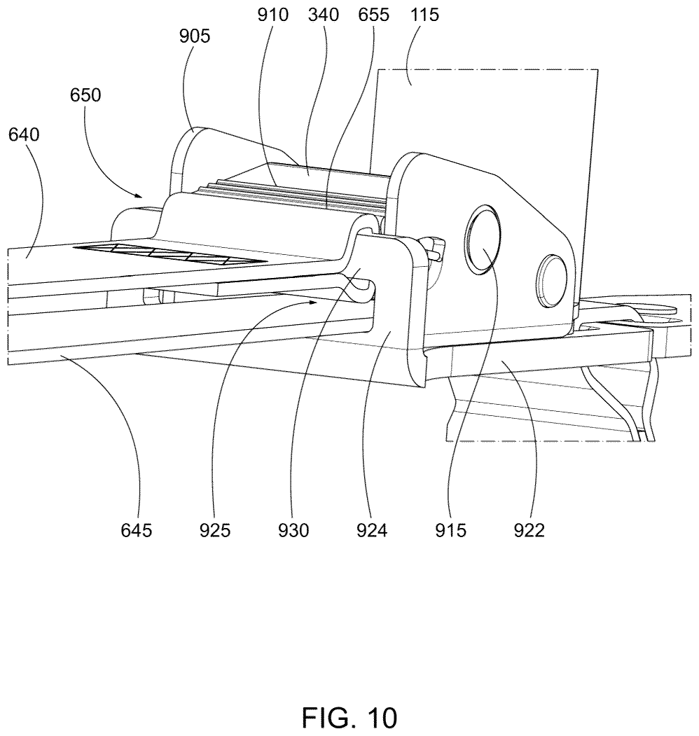

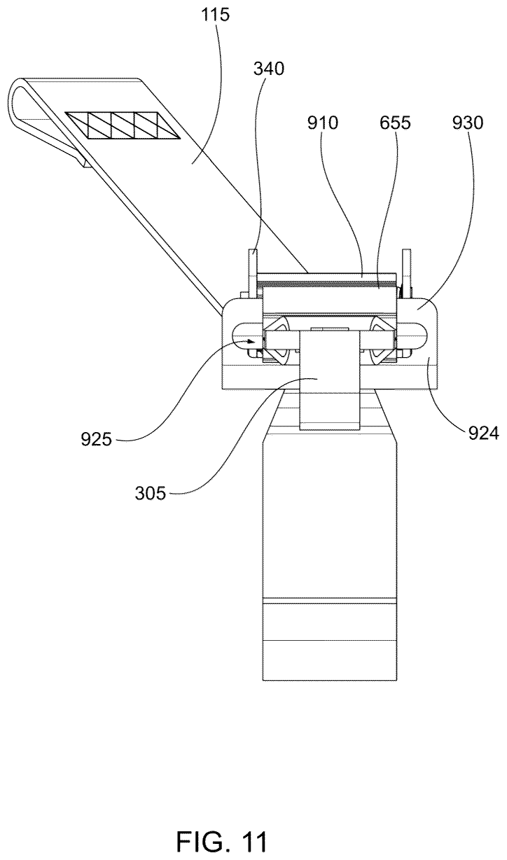

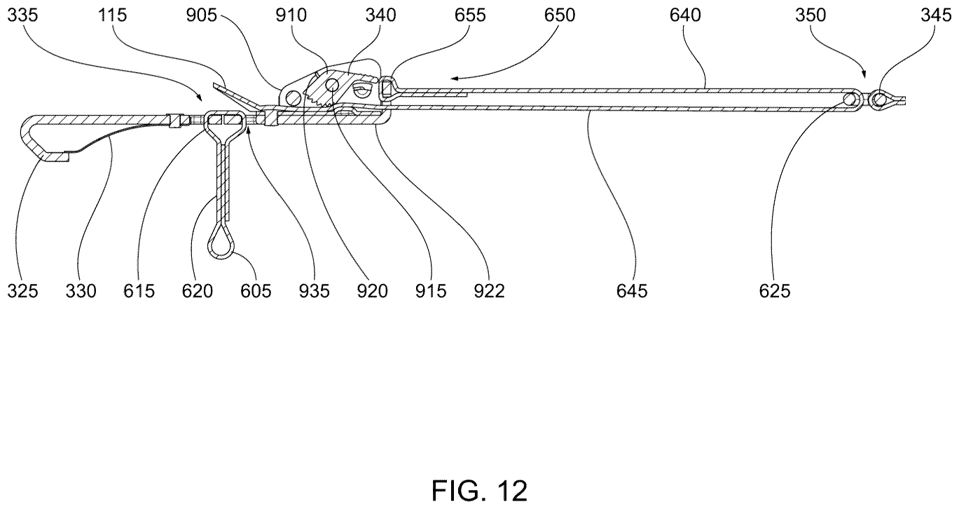

Turning now to FIGS. 9, 10, 11, and 12, the adjuster 337 in the illustrated example includes the cam buckle 340. The cam buckle 340 has a frame 905 and a cam 910 pivotally coupled to the frame 905 via a shaft 915. The cam buckle 340 further has a spring 920 that biases the cam 910 to a closed or engaged position when the cam 910 grips the adjustment strap 115. In the illustrated example, the spring 920 is a torsion spring that is wrapped around the shaft 915 and biased against the cam 910. Other types of springs or even no springs can be used in other examples. The frame 905 of the cam buckle 340 has a base 922 that extends generally parallel to the longitudinal axis 675. The pull angle 670 of the free end 657 of the adjustment strap 115 is typically measured relative to the base 922. At the end proximal to the adjuster end 650 of the adjustment strap 115, the frame 905 of the cam buckle 340 has an end wall 924 that extends perpendicular or transverse to the base 922. The end wall 924 of the frame 905 defines an exit or adjustment strap opening 925 through which the adjustment strap 115 extends through the cam buckle 340. With the adjustment strap opening 925, the end wall 924 of the frame 905 forms an anchor bar 930 around which the adjuster loop 655 at the adjuster end 650 of the adjustment strap 115 is secured. The cover section 640 of the adjustment strap 115 at the adjuster end 650 in one form is sewn together to form the adjuster loop 655, but it should be recognized that the adjuster end 650 of the adjustment strap 115 can be secured in other ways to the cam buckle 340.

At the end of the cam buckle 340 opposite to the end wall 924, the base 922 of the frame 905 defines a bridge opening 935 through which the bridge loop 615 of the bridge strap 605 is looped to join the anchor connector 305 and the cam buckle 340 together. The bridge strap 605 is typically sewn together at the reinforced portion 620 to form the bridge loop 615 that extends through the connector opening 335 of the anchor connector 305 and the bridge opening 935 of the cam buckle 340. In other variations, the anchor connector 305 and the cam buckle 340 can be coupled together in other manners.

As shown, the cam 910 has a lever 940 and an engagement portion 945 generally disposed on opposite sides of the shaft 915. The tension section 645 of the adjustment strap 115 generally extends through the cam buckle 340 along the base 922. The spring 920 biases the cam 910 to a closed or engaged position where the engagement portion 945 presses the adjustment strap 115 against the base 922 of the frame. When the cam 910 is in an engaged position, the engagement portion 945 engages the adjustment strap 115 so as to lock the adjustment strap 115 in place to prevent the adjustment strap 115 from being pulled out of the adjustment strap opening 925 in the cam buckle 340. In the depicted example, the engagement portion 945 has one or more teeth 950 configured to bite into the adjustment strap 115 so as to hold the adjustment strap 115 in place under tension. The base 922 of the frame 905 has a hump 955 generally disposed along the travel path of the adjustment strap 115 between the engagement portion 945 of the cam 910 and the adjustment strap opening 925 in the adjustment strap opening 925. The engagement portion 945 of the cam 910 in conjunction with the hump 955 forms a bend or kink in the adjustment strap 115 so as to further hold the adjustment strap 115 in place when under tension. When the installer 120 depresses or otherwise actuates the lever 940, the cam 910 pivots about the shaft 915 such that the engagement portion 945 disengages from the adjustment strap 115. Once the engagement portion 945 disengages from the adjustment strap 115, the adjustment strap 115 is able to slide freely relative to the cam buckle 340 such that the anchor strap device 105 can be loosened, if so desired. After the lever 940 is released, the spring 920 biases the cam 910 so that the engagement portion 945 reengages the adjustment strap 115 so as to maintain the current tension level. When the engagement portion 945 is engaged with the adjustment strap 115, the installer 120 can pull on the free end 657 of the adjustment strap 115 so as to further tighten the anchor strap device 105 if needed.

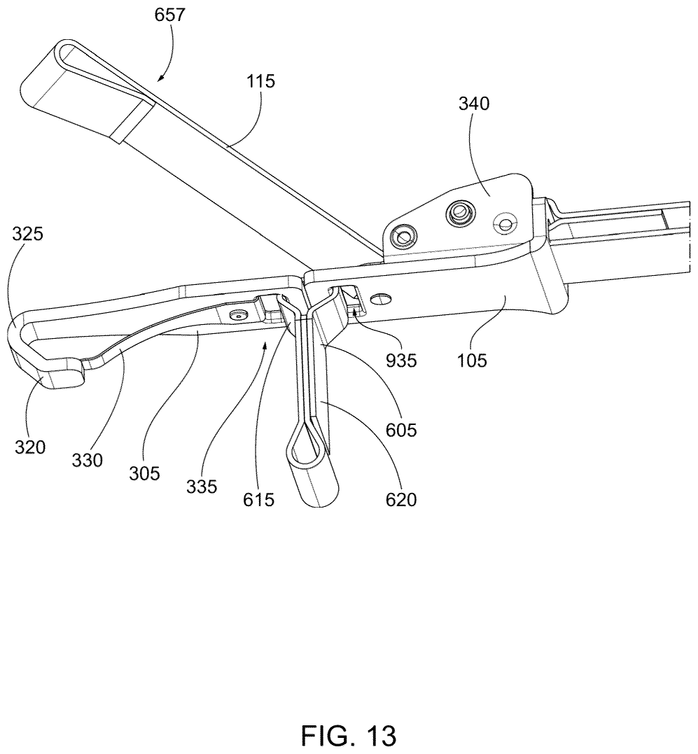

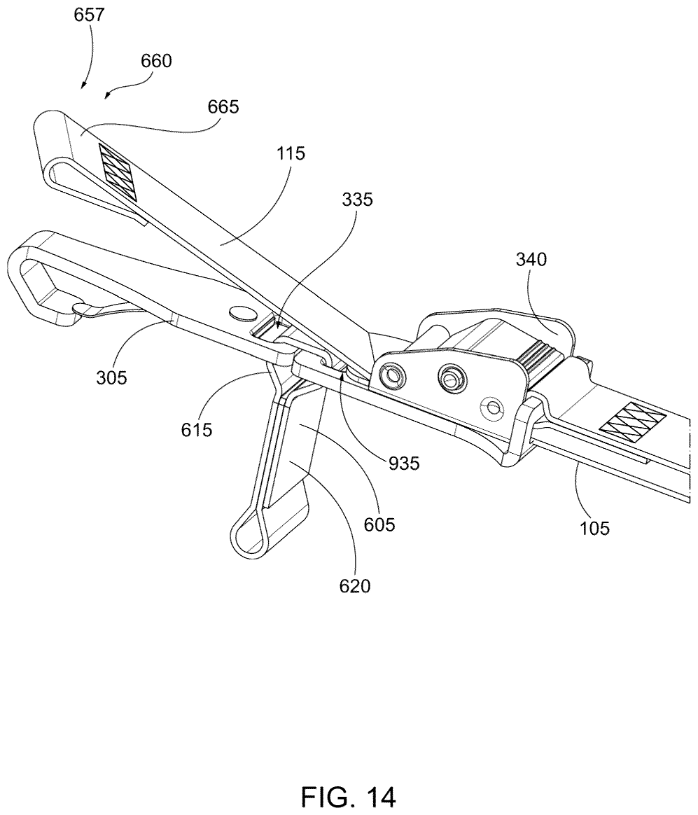

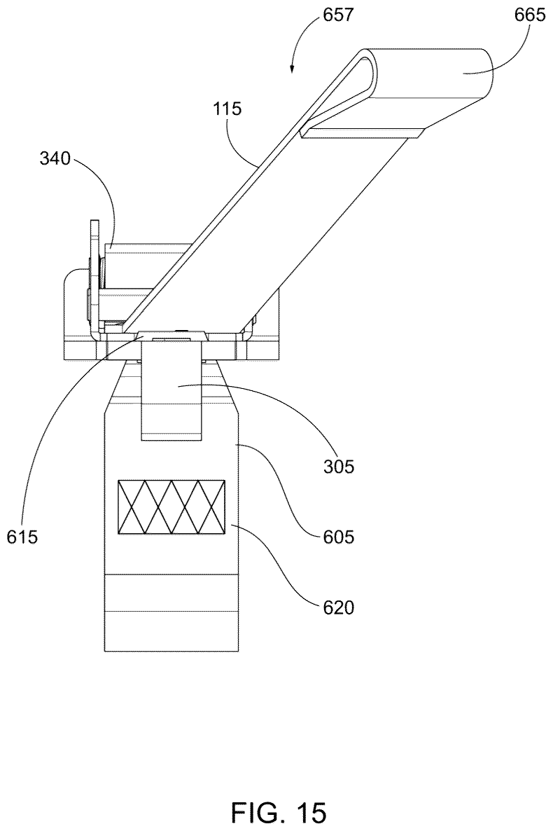

FIGS. 13, 14, and 15 show various views of the anchor strap device 105 at the end where the anchor connector 305 is connected to the cam buckle 340. Again, the anchor connectors 305 is directly coupled to the cam buckle 340 via the bridge strap 605 such that there is little distance between the anchor connector 305 and the cam buckle 340 as compared to the opposite anchor connector 305. In the depicted example, the anchor connector 305 at the cam buckle 340 is only able to generally pivot or bend away from the longitudinal axis 675 along a single axis. The reinforced portion 620 in the bridge strap 605 generally inhibits other relative motions between the anchor connector 305 and the cam buckle 340. The anchor connector 305 is still able to be bent down towards the anchor 225 in the vehicle seat 220 so as to facilitate anchoring of the anchor connector 305, but this single axis motion inhibits other twisting or binding actions that might increase friction or otherwise inhibit the pulling action of the adjustment strap 115 through the cam buckle 340. The bending direction of the anchor connector 305 at the cam buckle 340 generally matches the direction of the pull angle 670. This configuration allows the free end 657 of the adjustment strap 115 to be generally pulled straight through the cam buckle 340 with minimal friction.

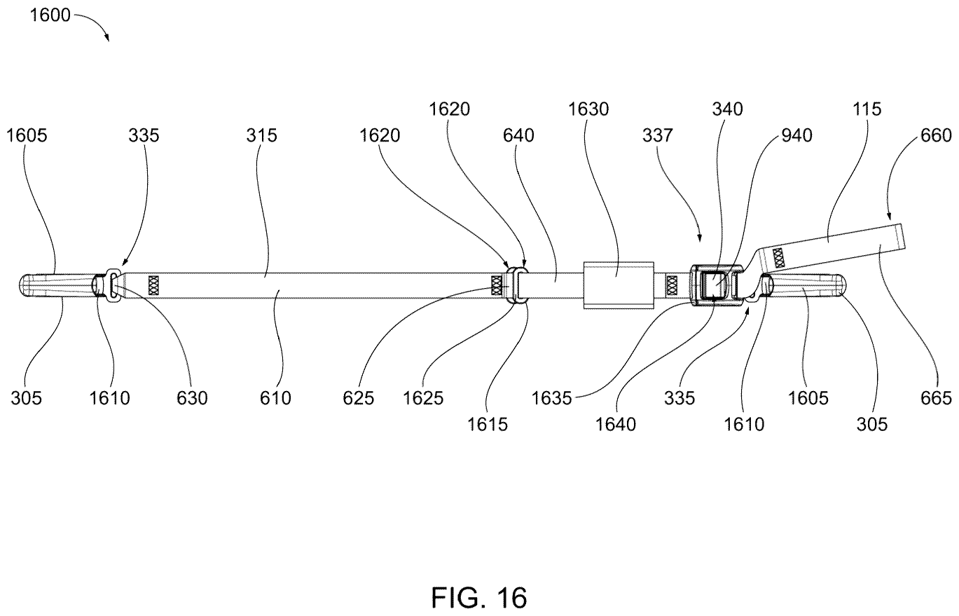

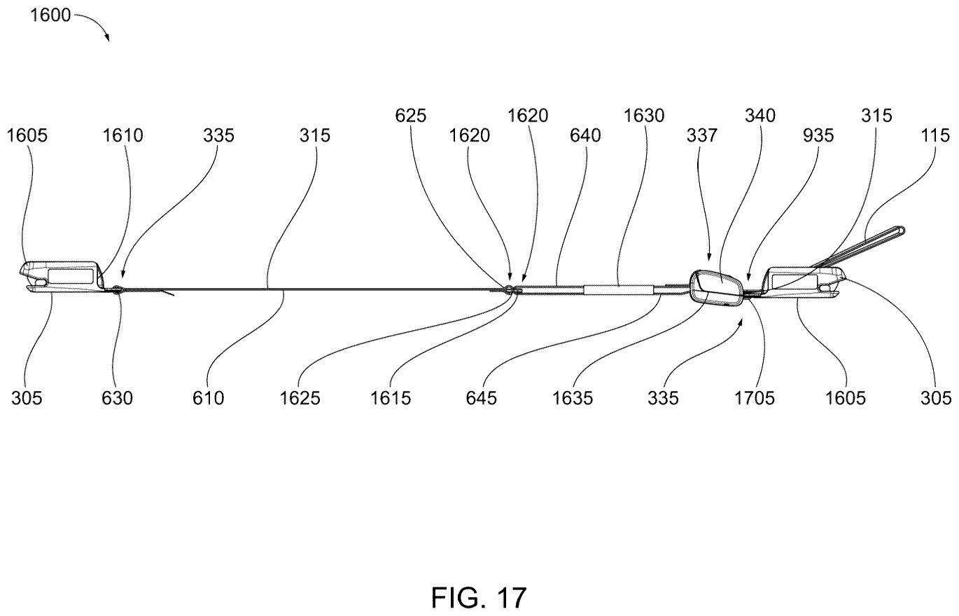

An anchor strap device 1600 according to another example that can be used to secure the child safety seat 110 in the vehicle 205 will now be described with reference to FIGS. 16 and 17. The anchor strap device 1600 in FIG. 16 generally shares several components in common with the anchor strap device 105 shown in FIG. 3, and the anchor strap device 1600 in FIG. 16 is constructed in a fashion similar to the anchor strap device 105 shown in FIG. 3. For example, the anchor strap device 1600 at least includes the adjustment strap 115, the adjuster 337, the guide strap 610, the cover section 640, and the tension section 645 of the type described above with respect to the anchor strap device 105 of FIG. 3. Moreover, the anchor strap device 1600 of FIG. 16 operates or functions in generally the same fashion as described above with respect to the anchor strap device 105 of FIG. 3. For the sake of brevity as well as clarity, these common components and their function will not be again described in detail, but please refer to the previous discussion.

As can be seen, the anchor strap device 1600 includes the anchor connectors 305 located at opposite ends of the anchor strap device 1600. In the FIG. 16 example, the anchor connectors 305 are in the form of mini-connectors 1605 that are configured to secure to the anchors 225 in the vehicle 205. The mini-connectors 1605 in the illustrated example each include a release button 1610. When pressed, the button 1610 releases or disconnects the mini-connector 1605 from the anchor 225. Like before, the mini-connectors 1605 each have the connector opening 335 where the connector straps 315 are secured. For example, the guide strap 610 is secured to the mini-connector 1605 via the connector loop 630 that is looped through the connector opening 335 in the mini-connector 1605.

The anchor strap device 1600 includes a guide 1615 with one or more guide slots 1620. In one form, the guide 1615 is made of metal, but the guide 1615 can be made from other materials, such as plastics, in other variations. In the depicted example, the guide 1615 defines two guide slots 1620 that are separated by a separator bar 1625. One of the guide slots 1620 is configured to receive the guide loop 625 of the guide strap 610 to secure the guide strap 610 to the guide 1615, and the other guide slot 1620 slidably receives the adjustment strap 115. With this construction of the guide 1615, the guide strap 610 and the adjustment strap 115 are received in separate guide slots 1620 and separated by the separator bar 1625 so as to minimize friction and wear between the adjustment strap 115 and the guide strap 610. At the guide 1615, the adjustment strap 115 is folded or routed to form the cover section 640 and the tension section 645.

As shown, the anchor strap device 1600 has a sleeve 1630 where portions of the cover section 640 and the tension section 645 are covered. The cover section 640 and the tension section 645 of the adjustment strap 115 extend through the sleeve 1630, and the adjustment strap 115 is able to slide relative to the sleeve 1630. The sleeve 1630 inhibits snagging, twisting, or otherwise binding of the adjustment strap 115 during tightening or loosening of the adjustment strap 115. In other words, the sleeve 1630 helps to protect and guide the cover section 640 and the tension section 645 of the adjustment strap 115 during tightening and loosening of the anchor strap device 1600.

The adjuster 337 in the anchor strap device 1600 of FIGS. 16 and 17 includes the cam buckle 340 of the type described before. In the illustrated example, the cam buckle 340 is housed within a housing 1635. In one form, the housing 1635 is made of plastic, but the housing 1635 in other variations can be made of other materials such as various metals. The housing 1635 in the illustrated example has a clam shell design that receives the frame 905, the cam 910, and the other components of the cam buckle 340, but the housing 1635 in other examples can be constructed differently. The housing 1635 defines an adjuster opening 1640 where the lever 940 of the cam 910 is able to be pressed or otherwise actuated to release and loosen the adjustment strap 115.

Referring to FIG. 17, the connector strap 315 at the adjuster 337 in the depicted example includes a bridge strap 1705 in the form of looped webbing. The bridge strap 1705 directly couples the adjuster 337 to the mini-connector 1605. The bridge strap 1705 is looped through the connector opening 335 in the mini-connector 1605 and the bridge opening 935 in the adjuster 337. In one form, the bridge strap 1705 limits the relative movement of the mini-connector 1605. For instance, the movement of the mini-connector 1605 relative to the adjuster 337 is limited to two degrees of freedom. In other words, the mini-connector 1605 is able to bend or pivot relative to the adjuster 337 along a single axis.

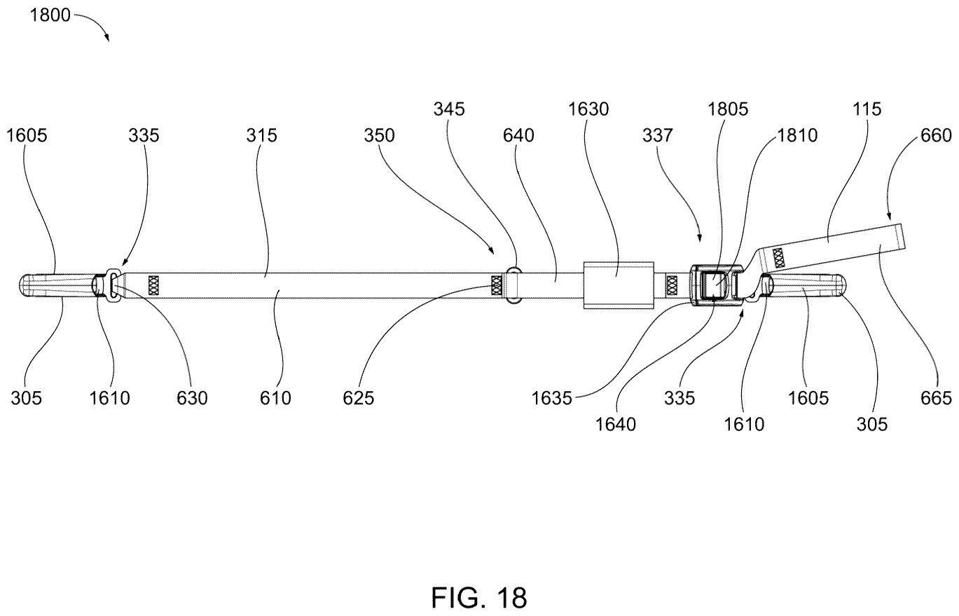

An anchor strap device 1800 according to still yet another example that can be used to secure the child safety seat 110 in the vehicle 205 will now be initially described with reference to FIG. 18. The anchor strap device 1800 in FIG. 18 generally shares several components in common with the anchor strap device 105 shown in FIG. 3 and the anchor strap device 1600 shown in FIG. 16. The anchor strap device 1800 in FIG. 18 is constructed in a fashion similar to the anchor strap device 105 shown in FIG. 3 and the anchor strap device 1600 shown in FIG. 16. For example, the anchor strap device 1800 at least includes the adjustment strap 115, the anchor connectors 305 in the form of the mini-connectors 1605, the adjuster 337, the guide 345 with the guide slot 350, the guide strap 610, the cover section 640, the tension section 645, and the sleeve 1630 of the types described above with respect to the anchor strap device 105 of FIG. 3 and the anchor strap device 1600 of FIG. 16. As can be seen, the anchor strap device 1800 includes the anchor connectors 305 located at opposite ends of the anchor strap device 1800. In the FIG. 18 example, the anchor connectors 305 are in the form of mini-connectors 1605 that are configured to secure to the anchors 225 in the vehicle 205. Moreover, the anchor strap device 1800 of FIG. 18 operates or functions in generally the same fashion as described above with respect to the anchor strap device 105 of FIG. 3 and the anchor strap device 1600 of FIG. 16. For the sake of brevity as well as clarity, these common components and their function will not be again described in detail, but please refer to the previous discussion.

Like in the previously described examples, the adjuster 337 in the FIG. 18 anchor strap device 1800 has a cam buckle 1805 that is constructed slightly differently to accommodate a bridge strap 1810 that connects the cam buckle 1805 to one of the anchor connectors 305. As in the previous examples, the bridge strap 1810 is used to limit degrees of freedom to maximize adjustment forces and case of use. In the FIG. 18 example, the bridge strap 1810 is mostly captured or housed inside the cam buckle 1805.

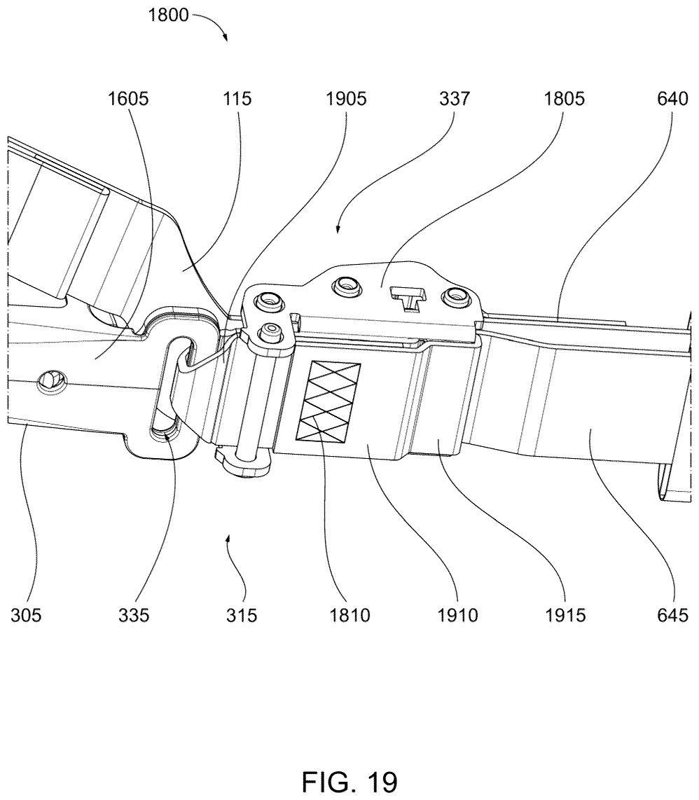

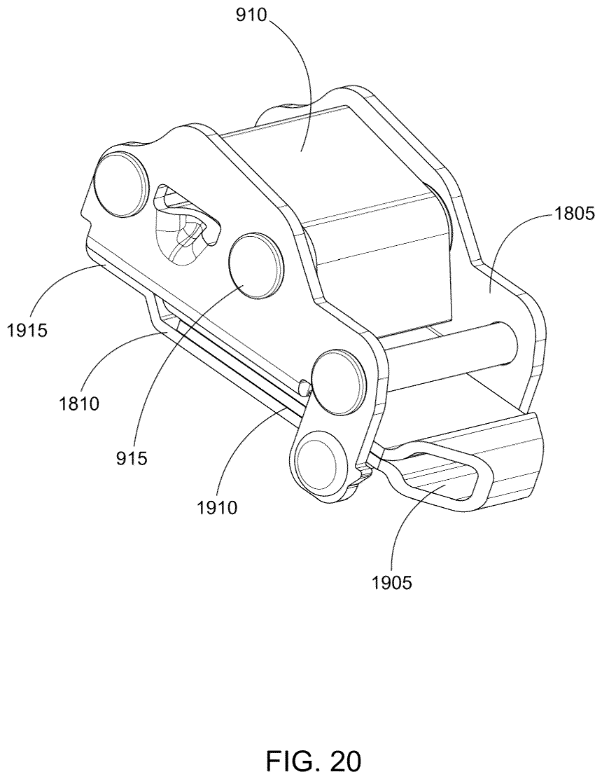

Turning to FIGS. 19 and 20, the bridge strap 1810 is tucked inside and underneath the cam buckle 1805. In one form, the bridge strap 1810 is made from webbing, but the bridge strap 1810 can be made from other materials. The bridge strap 1810 includes a bridge loop 1905 that is looped through the connector opening 335 in the anchor connector 305 to secure the cam buckle 1805 of the anchor connector 305. The bridge strap 1810 further has a reinforced portion 1910 that stiffens the bridge strap 1810. As can be seen, the reinforced portion 1910 extends along the base of the cam buckle 1805 so as to further stiffen the bridge strap 1810. At the reinforced portion 1910, the bridge strap 1810 is folded and sewn together to form two, three, or more layers at the reinforced portion 1910 so as to stiffen the bridge strap 1810 at the reinforced portion 1910. In other variations, the reinforced portion 1910 can include more layers and/or be stiffened in other ways. At the end opposite to the bridge loop 1905, the bridge strap 1810 has a frame loop 1915 that secures the bridge strap 1810 to the cam buckle 1805. The frame loop 1915 is secured to the end of the cam buckle 1805 that is opposite to where the anchor connector 305 is secured to the bridge loop 1905 of the bridge strap 1810. As shown, the reinforced portion 1910 is disposed between the bridge loop 1905 and the frame loop 1915.

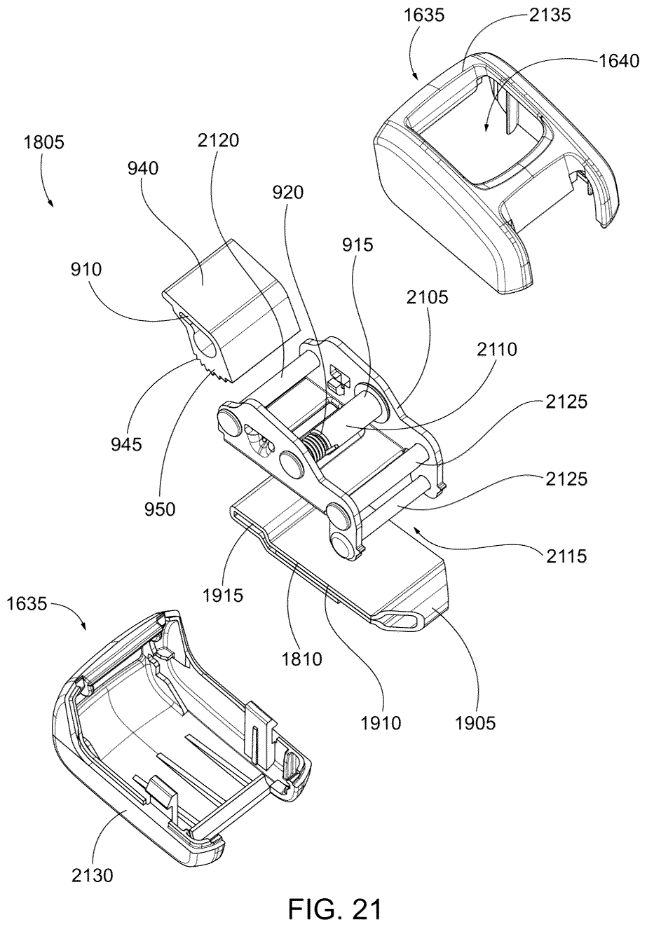

Referring to FIG. 21, the cam buckle 1805 operates in a similar fashion and shares a number of components in common with the previously described cam buckles. For instance, the cam buckle 1805 includes the cam 910 that is pivotally mounted to the shaft 915. The cam buckle 1805 further includes the spring 920 that biases the cam 910 to the engaged position or state where the teeth 950 of the engagement portion 945 bite into the adjustment strap 115 to maintain tension in the adjustment strap 115. As shown, the cam buckle 1805 has a frame 2105 to which the cam 910 and the shaft 915 are mounted. The shaft 915 extends across the frame 2105, and both ends of the shaft 915 are secured to the frame 2105. The cam buckle 1805 further includes a collar 2110 received around the shaft 915 to reduce friction between the cam 910 and the shaft 915.

In addition to the shaft 915, the cam buckle 1805 has one or more rivets or pins 2115 that extend across the frame 2105. The pins 2115 are configured to guide and/or secure various webbing such as the adjustment strap 115 and the bridge strap 1810. The pins 2115 include an anchor pin 2120 to which the adjuster loop 655 at the adjuster end 650 of the adjustment strap 115 is looped around to secure the adjuster end 650 of the adjustment strap 115 to the frame 2105 of the cam buckle 1805. The pins 2115 of the cam buckle 1805 further include one or more guide pins 2125 that are configured to guide or position the adjustment strap 115 and/or the bridge strap 1810. In the illustrated example, the cam buckle 1805 includes two guide pins 2125, but the cam buckle 1805 in other examples can include more or less guide pins 2125 than is shown. The guide pins 2125 are spaced apart from one another at the end of the cam buckle 1805 that is opposite to the anchor pin 2120. When assembled, portions of the adjustment strap 115 and the bridge strap 1810 extend between the guide pins 2125.

In the illustrated example, the housing 1635 has a clam shell design. In particular, the bridge strap 1810 has a base shell 2130 that is sandwiched to a cover shell 2135 to form the housing 1635. When the cam buckle 1805 is assembled, the frame 2105 of the cam buckle 1805 is housed inside the base shell 2130 and the cover shell 2135. The cover shell 2135 defines the adjuster opening 1640 which provides access to the lever 940 of the cam 910. The adjuster opening 1640 in the cover shell 2135 recesses or protects the lever 940 from accidental actuation.

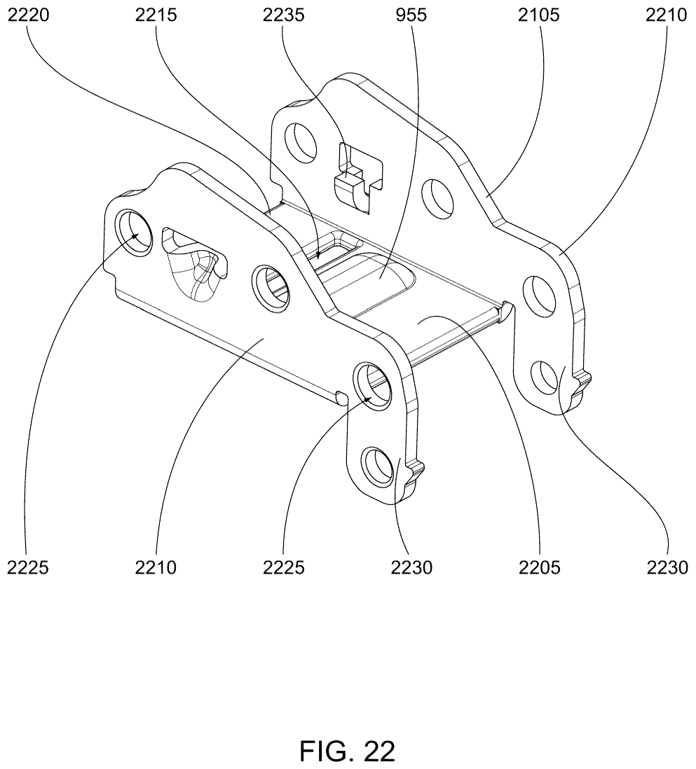

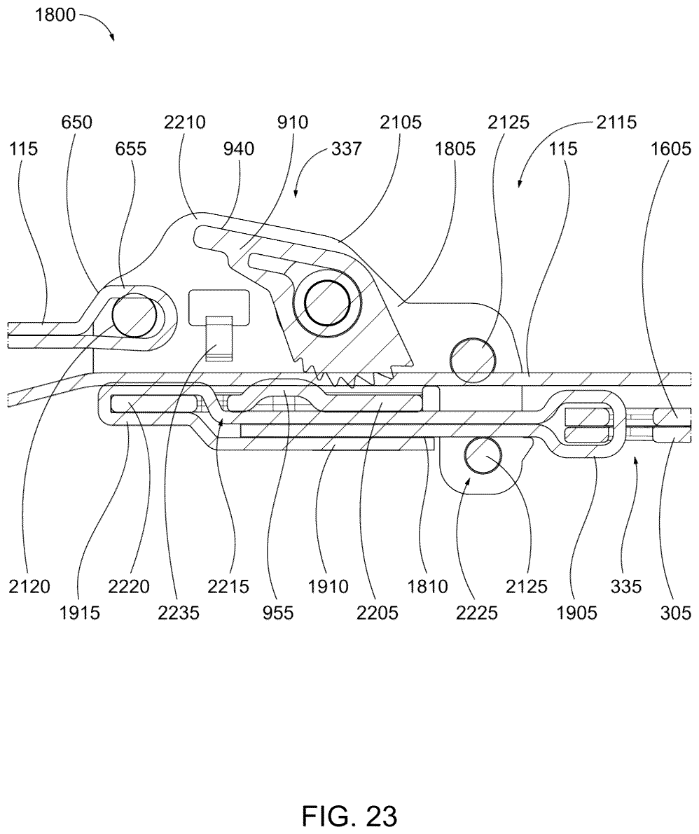

Referring now to FIGS. 22 and 23, the frame 2105 has a base 2205 and one or more sidewalls 2210 extending transverse from the base 2205. In the depicted example, the frame 2105 has two sidewalls 2210 extending on opposing sides of the base 2205. The base 2205 has the hump 955 of the type described before. The base 2205 defines a bridge slot 2215 through which the frame loop 1915 of the bridge strap 1810 is looped. The bridge slot 2215 in the base 2205 creates a bridge bar 2220 around which the frame loop 1915 of the bridge strap 1810 is looped and secured. When secured, the reinforced portion 1910 of the bridge strap 1810 runs along the base 2205 to further stiffen the bridge strap 1810.

In the illustrated example, the sidewalls 2210 define one or more mounting holes 2225 where the shaft 915 and the pins 2115 are mounted. When mounted, the shaft 915 and the pins 2115 extend between the sidewalls 2210. The sidewalls 2210 each further have a guide flange 2230 that extends transverse to and below the base 2205. The guide pins 2125 are mounted to the guide flanges 2230 so as to align and guide the adjustment strap 115 and the bridge strap 1810. Proximal to the lever 940 of the cam 910, the sidewalls 2210 have one or more stops 2235 that limit the movement or travel of the lever 940 when pressed.

As can be seen in FIG. 23, the anchor pin 2120 and the bridge bar 2220 are positioned at the same end of the cam buckle 1805. With this orientation, the adjuster loop 655 at the adjuster end 650 of the adjustment strap 115 and the frame loop 1915 of the bridge strap 1810 tend to overlap. The bridge strap 1810 is captured by the frame 2105 inside the housing 1635 of the anchor strap device 1800. This construction promotes efficient tensioning of the anchor strap device 1800.

One example method of installing the child safety seat 110 into the vehicle 205 with the anchor strap device 105 will now be generally described with reference to FIGS. 2, 3, 6, and 9. While the method will be described with reference to the anchor strap device 105 shown in FIG. 3, it should be appreciated that other types of anchor strap devices, such as the anchor strap device 1600 in FIG. 16 and the anchor strap device 1800 in FIG. 18, can be used to perform this method. It also should be noted that the order of the various activities can be different from the manner as described below, and in various cases, some of the actions may be omitted. Before or during installation, the anchor strap device 105 can be threaded through the appropriate mounting structures within the child safety seat 110. With the door 210 open, the child safety seat 110 is moved through the door opening 215 and placed on the vehicle seat 220 where the child safety seat 110 is desired to be mounted. With the anchor strap device 105 loosened, the anchor connectors 305 are clipped or otherwise secured to the appropriate anchors 225 in the vehicle seat 220. Typically, but not always, the end of the anchor strap device 105 with the cam buckle 340 at the free end 657 of the adjustment strap 115 is placed at the door opening 215. Once the anchor connectors 305 are secured to the anchors 225, the installer 120 is able to tighten the anchor strap device 105 by pulling on the handle 660 at the free end 657 of the adjustment strap 115. The installer 120 is able to pull in a sideways direction relative to the child safety seat 110 from outside of the vehicle 205. The installer 120 is able to utilize leverage to readily achieve the required tension level for properly securing the child safety seat 110 in the vehicle 205. Once the desired tension of the anchor strap device 105 is achieved, the installer 120 is able to release the handle 660 of the anchor strap device 105. The cam buckle 340 is designed to maintain the tension in the cover section 640 and the tension section 645 of the adjustment strap 115.

To uninstall or remove the child safety seat 110 from the vehicle 205, the installer 120 actuates or presses the lever 940 of the cam buckle 340 which releases the tension in the adjustment strap 115. Once the adjustment strap 115 in the anchor strap device 105 is loosened, the installer 120 is able to unclip the anchor connectors 305 from the anchors 225 in the vehicle 205. At this point, the child safety seat 110 can be removed from the vehicle 205 or repositioned within the vehicle 205.

### Glossary of Terms

The language used in the claims and specification is to only have its plain and ordinary meaning, except as explicitly defined below. The words in these definitions are to only have their plain and ordinary meaning. Such plain and ordinary meaning is inclusive of all consistent dictionary definitions from the most recently published Webster's dictionaries and Random House dictionaries. As used in the specification and claims, the following definitions apply to these terms and common variations thereof identified below.

“Anchor” generally refers to a structure that serves to firmly secure and/or hold an object. In other words, an anchor is a structure to which an object is fixed to prevent substantial movement.

“And/Or” generally refers to a grammatical conjunction indicating that one or more of the cases it connects may occur. For instance, it can indicate that either or both of the two stated cases can occur. In general, “and/or” includes any combination of the listed collection. For example, “X, Y, and/or Z” encompasses: any one letter individually (e.g., {X}, {Y}, {Z}); any combination of two of the letters (e.g., {X, Y}, {X, Z}, {Y, Z}); and all three letters (e.g., {X, Y, Z}). Such combinations may include other unlisted elements as well.

“Belt” generally refers to a narrow, flexible strip or band of material such as in the form of webbing or straps. The belt can be made of a unitary piece of material in some examples. In other examples, the belt can be made from multiple materials such as woven strands or wires found in webbing for seat belt systems.

“Buckle” generally refers to device, such as in the form of a clasp, that releasably secures two or more loose ends together. Typically, but not always one end is secured to or otherwise attached to the clasp device, and the other end is releasably or adjustably held by the clasp device. The ends can be for a variety of objects such as straps, belts, cables, and webbing, to name just a few. One common type of buckle is a seat belt buckle found in a wide variety of vehicles. For instance, the buckle can be used in two-point, three-point, four-point, five-point, or six-point harness systems. In one example, the loose end of a seat belt is looped through a slot in a latch plate that includes a tongue, and to secure the loose end, the tongue is inserted into a seat belt buckle that is attached to a fixed seat belt or webbing.

“Cam Buckle” generally refers to a device or mechanism that includes a frame and a cam (or jaw) pivotally coupled to the frame configured to lock a belt or webbing at a fixed position and/or length. The cam commonly, but not always, includes a lever or handle to allow a user to rotate the cam. The cam can be pivotally mounted to the frame in a number of ways such as through one or more pins and/or a shaft. In one use case example, a free end of the belt passes through a clearance or gap between the frame and the cam. When the cam is rotated relative to the frame, the size of the clearance gap between the cam and frame changes. For instance, rotating the cam in one direction reduces the clearance gap, and rotating the cam in the opposite direction increases the clearance gap. As an example, when the cam is rotated to a closed or locked position, the clearance gap between the cam and the frame is reduced such that the cam bites against the belt to clamp the belt between the cam and frame. In some designs, the cam has a knurled or serrated gripping surface configured to bite against the belt, and in other designs, the gripping surface can be generally smooth or have other types of textures. As tension is applied to the belt, the cam is configured to further rotate which in turn reduces the clearance so as to increase the biting force applied by the cam against the belt. To release the belt, the cam is rotated in the opposite to an opened or unlocked (released) position, the clearance gap between the cam and the frame increases to such a point where the cam no longer grips or bites into the belt. When the cam is in the opened position, the belt is able to slide relative to the cam buckle such that the belt can even be removed from the cam buckle. In some design configurations, the cam buckle further includes a spring or other biasing device that biases the cam to either the opened or closed position. In one design variation, the spring is coupled between the cam and frame so as to bias the cam to the closed position where the belt is locked in place. In such a case, the user presses against or otherwise actuates the lever of the cam to release the belt. The cam buckle can be made from a variety of materials such as metal and/or plastic, and the cam buckle can come in a variety of shapes, sizes, and types. Cam buckles can be used in a large number of ways such as for securing equipment, child safety seats, or even belts for clothing. For example, one type of cam buckle for child restraint systems is sold under the brand A-LOK® by Indiana Mills and Manufacturing, Inc. (IMMI).

“Child Safety Seat”, “Car Seat”, or “Child Restraint System (CRS)” generally refer to a seat that is specifically designed to protect children from injury during a vehicle collision. Commonly, the child safety seat is an aftermarket product that is installed by an owner into a vehicle after purchase of the vehicle, but the child safety seat can be also integrated into a seat of the vehicle by a manufacturer of the vehicle. In contrast to most vehicle seats, which are designed to accommodate adults, the child safety seat is sized and configured to properly position a child or infant to reduce injury during an accident. The child safety seat further typically includes a passive restraint system, such as a harness, that generally holds an occupant of the seat in place during a collision. The restraint system for example can include a five-point harness, but other types of harnesses and restraints can be used. When sold as a separate, aftermarket product, the child safety seat can include an anchoring mechanism, like an Isofix connector, configured to secure the child safety seat to the vehicle (e.g., via an Isofix anchor in the vehicle). Some typical types of child safety seats include infant seats, convertible seats, combination seats, and booster seats, just to name a few.

“Couple” or “Coupled” generally refers to an indirect and/or direct connection between the identified elements, components, and/or objects. Often the manner of the coupling will be related specifically to the manner in which the two coupled elements interact.

“Handle” generally refers to a part that is designed especially to be grasped by a human hand. In other words, a handle is a part by which an object, such as a tool or device, is held, carried, and/or controlled by a human hand. A handle typically has sufficient strength to support the object. For tools, the handle typically has sufficient strength to transmit any force from the handle to perform the designed functionality for the tool. The handle usually has a sufficient length to accommodate a single hand or multiple hands to grip and reliably exert force through the handle. Similarly, the handle commonly has a sufficiently small circumference or exterior size to permit single hand or multiple hands to reliably grip the handle. Other ergonomic factors, such friction, coating, grip, and injury prevention features, can be incorporated into the handle. By way of non-limiting examples, the handles can include broom handles, shovel handles, pull handles, or twist handles, to name just a few.

“Harness” generally refers to a set of straps and fittings for fastening a human or other animal in a particular place and/or position. The straps can come on many forms, such as belts, webbing, or ropes, and the straps can be made of a variety of materials such as natural or synthetic materials. The fittings are designed in a variety of forms for securing the straps around the individual as well as releasing the straps to free the individual. The harness can include webbing, buckles, latch plates, and/or length-adjustment mechanisms, such as a retractor. In one example, the fitting includes a set of latch plates that are secured in a buckle release mechanism. Harnesses can for instance be integrated into vehicle seats, child booster seats, and child safety seats. The straps and fitting can be configured in a number of manners such as to form three-point, five-point, and six-point harnesses, to name just a few examples.

“Hole” generally refers to a hollow portion through a solid body, wall, or a surface. A hole may be any shape. For example, a hole may be, but is not limited to, circular, triangular, or rectangular. A hole may also have varying depths and may extend entirely through the solid body or surface or may extend through only one side of the solid body.

“Hook” generally refers to a length of material that contains a portion that is curved and/or indented, such that it can be used to grab onto, connect, or otherwise attach itself onto another object. In one non-limiting example, the hook includes a piece of material, such as made of metal and/or plastic, that is curved or otherwise bent back at an angle, for catching hold of another object.

“Horizontal” generally refers to a plane and/or direction, which is parallel with the plane of the horizon. In another example, the horizontal plane and/or direction is at a right angle to a vertical plane or direction. An item that moves in the sideways (left to right) direction is generally said to move horizontally. For example, a lever fixed on one end to a rod that is able to move to the left and right is said to move horizontally. In yet another example, the slope of a horizontal line is 0.

“Housing” generally refers to a component that covers, protects, and/or supports another thing. A housing can have a unitary construction or be made of multiple components. The housing can be made from the same material or a combination of different materials. The housing can include a protective cover designed to contain and/or support one or more mechanical components. Some non-limiting examples of a housing include a case, enclosure, covering, body, and shell.

“Isofix” or “ISOFIX” generally refers to an international standard for attachment points for child safety seats in passenger cars and other vehicles and/or attachment point or anchoring systems that satisfy the standard. More specifically, Isofix refers to the International Organization for Standardization (ISO) standard ISO 13216, which specifies the anchoring system for Group 1 child safety seats. This standard defines standard attachment points to be manufactured into cars, enabling compliant child safety seats to be quickly and safely secured. Isofix acts as an alternative to securing the seat with seat belts. In one form, child safety seats are secured with a single attachment at the top (e.g., top tether) and two attachments at the base of each side of the seat. The Isofix standard can be identified by other regional names. In the United States for example, the standard is commonly referred to as a LATCH (“Lower Anchors and Tethers for Children”) system.

“Lateral” generally refers to being situated on, directed toward, or coming from the side.

“Lever” generally refers to a simple machine including a beam, rod, or other structure pivoted at a fulcrum, such as a hinge. In one form, the lever is a rigid body capable of rotating on a point on itself. Levers can be generally categorized into three types of classes based on the location of fulcrum, load, and/or effort. In a class 1 type of lever, the fulcrum is located in the middle such that the effort is applied on one side of the fulcrum and the resistance or load on the other side. For class 1 type levers, the mechanical advantage may be greater than, less than, or equal to 1. Some non-limiting examples of class 1 type levers include seesaws, crowbars, and a pair of scissors. In a class 2 type of lever, which is sometimes referred to as a force multiplier lever, the resistance or load is located generally near the middle of the lever such that the effort is applied on one side of the resistance and the fulcrum is located on the other side. For class 2 type levers, the load arm is smaller than the effort arm, and the mechanical advantage is typically greater than 1. Some non-limiting examples of class 2 type levers include wheelbarrows, nutcrackers, bottle openers, and automobile brake pedals. In a class 3 type lever, which is sometimes referred to as a speed multiplier lever, the effort is generally located near the middle of the lever such that the resistance or load is on one side of the effort and the fulcrum is located on the other side. For class 3 type levers, the effort arm is smaller than the load arm, and the mechanical advantage is typically less than 1. Some non-limiting examples of class 3 type levers include a pair of tweezers and the human mandible.

“Longitudinal” generally refers to the length or lengthwise dimension of an object, rather than across.

“Opening” generally refers to a space or hole that something can pass through.

“Pin” or “Peg” generally refers to an elongated piece of material such as wood, metal, plastic and/or other material. Typically (but not always), the pin is tapered at one or both ends, but the pin can be shaped differently in other examples. For example, the ends of the pin can be flattened, widened, and/or bent in order to retain the pin. Pins can be used for any number of purposes. For example, the pin can be used in machines to couple components together or otherwise act as an interface between components. Pins can also be used for holding things together, hanging things on, and/or marking a position. Normally, but not always, the pin is a small, usually cylindrical piece. In certain cases, the pin is a pointed and/or a tapered piece used to pin down, fasten things together, and/or designed to fit into holes. In other examples, the pin can have a polyhedral shape, such as with a rectangular or triangular cross-sectional shape, or an irregular shape.

“Seat Belt System” and “Safety Belt System” generally refer to an arrangement of webs, straps, and other devices designed to restrain or otherwise hold a person or other object steady such as in a boat, vehicle, aircraft, and/or spacecraft. For example, the seat belt is designed to secure an occupant of a vehicle against harmful movement that may result during a collision or a sudden stop. By way of non-limiting examples, the seat belt can include webbing, buckles, latch plates, and/or length-adjustment mechanisms, such as a retractor, installed in the vehicle that is used to restrain an occupant or a child restraint system. The seat belt for instance can include a lap belt only, a combination lap-shoulder belt, a separate lap belt, a separate shoulder belt, and/or a knee bolster.

“Snap Hook”, “Snap-Hook”, or “Snaphook” generally refer to a mechanism having a hook with a gate, guard, and/or spring biased to allow entrance but prevent removal of an anchor structure, such as a cord, ring, strap, eye, and the like, from the hook.

“Spring” generally refers to an elastic object that stores mechanical energy. The spring can include a resilient device that can be pressed, pulled, and/or twisted but returns to its former shape when released. The spring can be made from resilient or elastic material such as metal and/or plastic. The spring can counter or resist loads in many forms and apply force at constant or variable levels. For example, the spring can include a tension spring, compression spring, torsion spring, constant spring, and/or variable spring. The spring can take many forms such as by being a flat spring, a machined spring, and/or a serpentine spring. By way of nonlimiting examples, the springs can include various coil springs, pocket springs, Bonnell coils, offset coils, continuous coils, cantilever springs, volute springs, hairsprings, leaf springs, V-springs, gas springs, leaf springs, torsion springs, rubber bands, spring washers, and/or wave springs, to name just a few.

“Tilt-Lock Adjuster” generally refers to a belt, strap, and/or webbing adjustment mechanism that releases the hold of the mechanism on the belt for the purpose of releasing tension and/or lengthening the belt when the mechanism is lifted and/or held at an angle that is generally transverse to the general longitudinal direction of the belt. Typically, but not always, the tilt-lock adjuster does not inhibit the overall length of the belt from being shortened when the free end of the belt is pulled.

“Transverse” generally refers to things, axes, straight lines, planes, or geometric shapes extending in a non-parallel and/or crosswise manner relative to one another. For example, when in a transverse arrangement, lines can extend at right angles or perpendicular relative to one another, but the lines can extend at other non-straight angles as well such as at acute, obtuse, or reflex angles. For instance, transverse lines can also form angles greater than zero (0) degrees such that the lines are not parallel. When extending in a transverse manner, the lines or other things do not necessarily have to intersect one another, but they can.

“Vehicle” generally refers to a machine that transports people and/or cargo. Common vehicle types can include land-based vehicles, amphibious vehicles, watercraft, aircraft, and space craft. By way of non-limiting examples, land-based vehicles can include wagons, carts, scooters, bicycles, motorcycles, automobiles, vans, buses, trucks, semi-trailers, trains, trolleys, and trams. Amphibious vehicles can for example include hovercraft and duck boats, and watercraft can include ships, boats, and submarines, to name just a few examples. Common forms of aircraft include airplanes, helicopters, autogiros, and balloons, and spacecraft for instance can include rockets and rocket powered aircraft. The vehicle can have numerous types of power sources. For instance, the vehicle can be powered via human propulsion, electrically powered, powered via chemical combustion, nuclear powered, and/or solar powered. The direction, velocity, and operation of the vehicle can be human controlled, autonomously controlled, and/or semi-autonomously controlled. Examples of autonomously or semi-autonomously controlled vehicles include Automated Guided Vehicles (AGVs) and drones.

“Vertical” generally refers to a plane and/or direction, which is perpendicular to the plane of the horizon. In another example, vertical is an alignment where the top is directly above the bottom. An item that moves upward or downward is generally said to move vertically. For example, an item that is able to move up and down is said to move vertically. In another example, the slope of a vertical line is undefined.

“Web” or “Webbing” generally refers to a strap made of a network of thread, strings, cords, wires, and/or other materials designed to restrain or otherwise hold a person or other object steady such as in a boat, vehicle, aircraft, and/or spacecraft. By way of non-limiting examples, the web can be incorporated into a seat belt, a child booster seat, and/or a car seat.

It should be noted that the singular forms “a,” “an,” “the,” and the like as used in the description and/or the claims include the plural forms unless expressly discussed otherwise. For example, if the specification and/or claims refer to “a device” or “the device”, it includes one or more of such devices.

It should be noted that directional terms, such as “up,” “down,” “top,” “bottom,” “lateral,” “longitudinal,” “radial,” “circumferential,” “horizontal,” “vertical,” etc., are used herein solely for the convenience of the reader in order to aid in the reader's understanding of the illustrated embodiments, and it is not the intent that the use of these directional terms in any manner limit the described, illustrated, and/or claimed features to a specific direction and/or orientation.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by the following claims are desired to be protected. All publications, patents, and patent applications cited in this specification are herein incorporated by reference as if each individual publication, patent, or patent application were specifically and individually indicated to be incorporated by reference and set forth in its entirety herein.

### REFERENCE NUMBERS

100 system
105 anchor strap device
110 child safety seat
115 adjustment strap
120 installer
205 vehicle
210 door
215 door opening
220 vehicle seat
225 anchor
305 anchor connectors
310 tensioner
315 connector straps
320 snap hook
325 hook
330 gate
335 connector opening
337 adjuster
340 cam buckle
345 guide
350 guide slot
605 bridge strap
610 guide strap
615 bridge loop
620 reinforced portion
625 guide loop
630 connector loop
635 extension portion
640 cover section
645 tension section
650 adjuster end
655 adjuster loop
657 free end
660 handle
665 handle loop
670 pull angle
675 longitudinal axis
680 arrows
685 arrows
690 arrows
905 frame
910 cam
915 shaft
920 spring
922 base
924 end wall
925 adjustment strap opening
930 anchor bar
935 bridge opening
940 lever
945 engagement portion
950 teeth
955 hump
1600 anchor strap device
1605 mini-connector
1610 button
1615 guide
1620 guide slots
1625 separator bar
1630 sleeve
1635 housing
1640 adjuster opening
1705 bridge strap
1800 anchor strap device
1805 cam buckle
1810 bridge strap
1905 bridge loop
1910 reinforced portion
1915 frame loop
2105 frame
2110 collar
2115 pins
2120 anchor pin
2125 guide pins
2130 base shell
2135 cover shell
2205 base
2210 sidewalls
2215 bridge slot
2220 bridge bar
2225 mounting holes
2230 guide flanges
2235 stops

What is claimed is:

1. A system, comprising:
an anchor strap device is configured to be tightened via a side pulling action relative to a child safety seat;
wherein the anchor strap device includes a connector configured to connect to an anchor in a vehicle;
wherein the anchor strap device includes an adjustment strap;
wherein the anchor strap device includes an adjuster;
wherein the adjustment strap has an adjuster end secured to the adjuster;
wherein the adjuster is configured to maintain tension in the adjustment strap;
wherein the anchor strap device includes a guide;
wherein the adjustment strap extends through the guide;
wherein the adjustment strap is routed through the adjuster; and
wherein the adjustment strap has a free end that extends from the adjuster.

2. The system of claim 1, wherein the connector is directly coupled to the adjuster.

3. The system of claim 2, wherein the connector is configured to move with at most two degrees of freedom relative to the adjuster.

4. The system of claim 2, further comprising:
a bridge strap connecting the connector to the adjuster.

5. The system of claim 4, wherein:
the connector defines a connector opening;
the adjuster defines a bridge opening;
the bridge strap has a bridge loop looped through the connector opening and the bridge opening;
the bridge strap has a reinforced portion; and
the bridge strap limits relative motion between the connector and the adjuster to facilitate transmission of tensioning force of the adjustment strap.

6. The system of claim 4, wherein:
the adjuster includes a frame; and
the bridge strap is captured in the frame.

7. The system of claim 1, wherein the free end includes a handle.

8. The system of claim 1, wherein the adjuster includes a cam buckle.

9. The system of claim 1, wherein:
the adjuster includes a frame;
the frame has a base;
the frame has an end wall;
the end wall extends transverse to the base;
the adjuster has an adjustment strap opening where the adjustment strap extends through the adjuster; and
the adjustment strap opening is defined in the end wall.

10. The system of claim 9, wherein:
the end wall forms an anchor bar; and
the adjustment strap has an adjuster loop looped around the anchor bar.

11. The system of claim 9, wherein:
the adjustment strap has a cover section that extends from the adjuster end to the guide;
the adjustment strap has a tension section that extends from the guide to the adjustment strap opening in the adjuster; and
the cover section and the tension section are arranged to reduce friction during tensioning.

12. The system of claim 11, wherein the cover section covers the tension section of the adjustment strap.

13. The system of claim 11, wherein:
the anchor strap device includes a sleeve; and
the sleeve receives the cover section and the tension section of the adjustment strap.

14. The system of claim 1, further comprising:
a connector strap connecting the guide to the connector.

15. The system of claim 14, wherein:
the connector strap includes a guide strap; and
the guide strap is configured to twist to minimize twisting of the adjustment strap.

16. The system of claim 1, wherein the adjuster is positioned at one side of the child safety seat when secured.

17. A system, comprising:
an anchor strap device is configured to be tightened via a side pulling action relative to a child safety seat;
wherein the anchor strap device includes a connector configured to connect to an anchor in a vehicle;
wherein the anchor strap device includes an adjustment strap;
wherein the anchor strap device includes an adjuster;
wherein the anchor strap device includes a guide;
wherein the adjustment strap extends through the guide;
wherein the adjustment strap is routed through the adjuster;
wherein the anchor strap device includes a connector strap connected to the connector; and
wherein the connector strap is configured to facilitate tensioning of the adjustment strap.

18. The system of claim 17, wherein:
the connector strap includes a bridge strap; and
the bridge strap limits relative motion between the connector and the adjuster to facilitate transmission of tensioning force of the adjustment strap.

19. The system of claim 18, wherein:
the connector defines a connector opening;
the adjuster defines a bridge opening;
the bridge strap has a bridge loop looped through the connector opening and the bridge opening;
the bridge strap has a reinforced portion; and
the bridge strap limits relative motion between the connector and the adjuster to facilitate transmission of tensioning force of the adjustment strap.

20. The system of claim 17, wherein:
the connector strap includes a guide strap; and
the guide strap connects the guide to the connector.

21. The system of claim 20, wherein:
the guide strap has a single layer of webbing; and
the adjustment strap between the adjuster and the guide has at least two layers of webbing.

22. The system of claim 21, wherein:
the guide strap is configured to twist to facilitate connection of the connector to the anchor; and
the guide strap is configured to bend to facilitate connection of the connector to the anchor.
